(19) United States
(12) Patent Application Publication
(10) Pub. No.: US 2007/0298711 A1
(43) Pub. Date: Dec. 27, 2007

(54) Data processing equipment, and data processing program

(75) Inventor: Minoru Ogushi, Kodaira (JP)

Correspondence Address: Stanley P. Fisher;Reed Smith Hazel & Thomas LLP, Suite 1400, 3110 Fairview Park Drive, Falls Church, VA, 22042-4503, US

(73) Assignee: Hitachi, Ltd.

(21) Appl. No.: 11/812,640

(22) Filed: Jun. 20, 2007

(30) Foreign Application Priority Data
Jun. 23, 2006 (JP) 2006-173284

(51) Int. Cl. H04B 7/24

(52) U.S. Cl. 455/39; 709/213; 341/155

(57) ABSTRACT

A high-sound-quality speech function is implemented in a small-sized wireless terminal including inexpensive low-grade resources such as an inexpensive microprocessor and an inexpensive memory.

From data inputted to the terminal, a reproduction data sequence and identifying information defining reproduction timing to reproduce the reproduction data sequence are extracted. According to the identifying information, timing to output the reproduction data sequence to a Digital-to-analog (DA) converter is controlled. A sampling data sequence obtained by converting data inputted to the terminal from analog data to digital data is stored in a register. Depending on a difference between values of the sampling data, whether or not the sampling data is discarded is determined. A sequence of sampling data which is not discarded and which is stored in the register is recorded. Identifying information defining reproduction timing to reproduce the sampling data sequence and reproduction data are created to be outputted.

### INCORPORATION BY REFERENCE

The present application claims priority from Japanese application JP2006-173284 filed on Jun. 23, 2006, the content of which is hereby incorporated by reference into this application.

### FIELD OF THE INVENTION

The present invention relates to a technique to transmit and to reproduce voice and sound on a small-sized wireless terminal with low-grade resources.

### BACKGROUND OF THE INVENTION

Expectation has been expanding and increasing for realization of a ubiquitous society in which the user accesses desired information and conducts communication with a desired person at any time and from any place.

### SUMMARY OF THE INVENTION

The information society at present has been developed by technologies such as those of the internet and the portable telephone or cellular phones. Due to development of the internet and wide spread of the continuous broadband accessibility, there is constructed an environment in which various contents are distributed through networks for the user to access desired information at any time. Moreover, due to wide spread and development of cellular phones, there are also constructed an environment to access desired information from any place as well as an environment in which the user conducts communication with a desired person at any time and from any place.

For the speech or call function of cellular phones, a technique called Pulse Code Modulation (PCM) is basically employed as a method to convert or to encode a voice waveform into a digital code. According to the PCM, a voice waveform is sampled on the basis of a reference frequency and a reference quantization size to produce a reproduced data sequence. For the cellular phones, there is conducted a secondary decoding process to compress the data. That is, the data encoded according to the pulse code modulation is further encoded by use of, for example, time-series prediction and by referring to a code book. This enables transmission of voice or audio data with relatively high sound quality even through a low-speed communication path (reference is to be made to ITU-T Recommendation G.729 for International Standard Telecommunication Union (ITC)).

The conventional voice compression method (reference is to be made to ITU-T Recommendation G.729) is prepared on the premise of the reproduction and interpolation for compressed data and hence requires a large number of processing steps for the compression and the reproduction. Therefore, if it is desired to execute the processing in the voice compression method by a general processor, there is required an expensive and high-performance processor capable of executing floating-point operations at a high speed. For example, if a processor dedicated to the processing of signals like an Application Specific Integrated Circuit (ASIC) is employed, only the compression and the reproduction can be carried out by setting fixed parameters. Furthermore, since missing data disadvantageously leads to interruption of voice and sound, there are required the processor performance and the memory capacity enough to encode and to decode the waveform of the reference frequency in any situation.

Therefore, in the speech technique for devices such as a cellular phone, there exists a hardware requirement as a premise, that is, the hardware components are at a level equal to or more than a predetermined level. This means that when it is desired to possibly reduce the hardware resources to implement an inexpensive, small-sized speech terminal, there naturally exists a limit for the reduction. For example, it is difficult to implement such a speech function by use of an inexpensive, low-speed microprocessor employed, for example, to conduct simple control of electronic and electric appliances for family use. Also, if the speech function is desired to be mounted on a small-sized terminal such as a wristwatch having a device size which allows the watch to be comfortably and continuously carried about by the user, it is required to employ a processor and a memory which have a small size and high performance. As a result, the production cost tremendously soars.

It is therefore an object of the present invention, which has been devised to solve the problem, to achieve a speech function with high sound quality in a small-sized wireless terminal including inexpensive low-grade resources such as an inexpensive microprocessor and an inexpensive memory.

Description will now be given of an outline of representative aspects of the present invention. In a data reproducing apparatus of the present invention, a reproduction data sequence and identifying information to define reproduction timing of the reproduction data sequence is extracted from input data inputted to the apparatus. According to the identifying information, timing to output the reproduction data sequence is controlled. In a data transmitting apparatus of the present invention, analog data inputted thereto is converted into digital data, i.e., a sampling data sequence to be stored in a register. According to the difference between the sampling data values, whether or not the sampling data is discarded is determined. A sequence of sampling data items not discarded, i.e., kept remained in the register are recorded. The data transmitting apparatus produces and outputs identifying information defining reproduction timing of the recorded sampling data sequence as well as reproduction data.

According to the present invention, the speech can be conducted using a wireless terminal including remarkably low-grade resources. This leads to reduction in size of the wireless terminal having the speech function. Since the hardware requirement is lowered, the speech function can be mounted at a low cost also on a small-sized terminal such as a watch, which it has been heretofore difficult in the prior art.

The present invention has a premise in which the data inputted to the data reproducing apparatus is not data encoded with a fixed sampling period, but is data encoded with an arbitrary sampling period in time series.

According to one aspect of the present invention, the microprocessor of the data reproducing apparatus controls timing at which the voice or audio data sequence to be reproduced is outputted to a Digital-to-Analog (DA) converter. It is hence possible, by use of a small number of operation steps and a small memory capacity, to cope with voice data with such particular sampling period while retaining the realtime property in operation. In addition, according to one aspect of the present invention, there is provided a sound quality adjusting function to adjust the sound quality depending on the resources of the terminal and a voice compression function to compress voice with high sound quality.

By use of one or both of a microphone and a speaker, the present invention is suitably applied to a portable small-sized wireless terminal including one or both of a voice sampling function and a voice reproducing function.

Data available for the data processing method according to the present invention is data requiring a time-series input and/or a time-series output. Voice data is particularly suitable for the data processing method. Data similar to the voice data includes, for example, video data.

The data processing method is also useful for operation in fields such as the factory automation, the perception system of robots, and the sensor network in which a state changes with respect to time of a person, a thing or an object, an environment, or the like is measured to conduct a time-series analysis and/or a time-series control operation. Data types of data used in the data processing method includes, for example, the blood flow rate, the pulse, acceleration, vibration, distortion, pressure, and electric resistance. The data processing method is also available as a control method for a remote controller which transmits a signal indicating an operation of a handle or the like to a robot arm in a remote location.

The present invention is quite efficiently applicable to a field in which a strong restriction is imposed on the microprocessor performance and the memory capacity in the time-series data reproducing and producing apparatuses and hence data is communicated through a low-speed, low-quality transmission path not suitable for the transmission of rich contents. In this sense, the present invention is quite suitably applicable to a field of wearable terminals for which the downsizing and low power consumption are strongly required and a field of the sensor net and information appliances for house use in which short-distance, low-speed wireless, and low-power-consumption communication is employed. However, the present invention is not restricted by these application fields, but various applications of the present invention can also be considered.

For example, a server unit which accumulates contents such as video and audio contents and which distributes, in response to a content request of a content from a user in an on-demand mode, the content to the user ordinarily includes a processor having quite high processing performance, a large-capacity memory, a large-capacity hard disk, and a quite-high-speed wired communication interface with high communication quality (e.g., gigabit ethernet).

However, with the development of the ubiquitous society, the accesses from users to the contents are increasing to surpass the improvement in performance on the server side. By applying the present invention to the server unit in this situation, it is possible to reduce the resources such as the amount of arithmetic operations, the memory capacity, and the communication band required to distribute each content. It is hence possible to cope with the increasing accesses. Assume that the increase in the accesses from users can be coped with by the performance improvement on the server side. If an inexpensive server unit not having quite high performance can be used without greatly reducing the content distribution quality, the present invention leads to a remarkable advantage for hardware business and contents business.

According to the present invention, in the operation to input, to transmit, and to output time-series data, the number of operation steps and the storage area required for the input device and the transmission device are reduced while retaining the output quality. Therefore, the time-series data input, transmission, and output operations can be carried out by use of an apparatus including inexpensive low-grade resources as compared with the conventional apparatus. Also, a large number of data items can be efficiently processed. The present invention is applicable to a wide variety of fields regardless of the wired or wireless communication as well as the realtime or non-realtime operation mode. For example, by use of a small-sized, low-grade-resource wearable wireless terminal which is quite smaller than the cellular phone and which includes lower-grade resources as compared with the cellular phone, there can be achieved a realtime call similar to that achieved using the cellular phone. In addition, the present invention is applicable to the on-demand transmission system (transmission of stream type or bulk type) in which data input operation is beforehand conducted in a preparative operation phase as in the content distribution and in which the data is saved in, for example, a large-capacity hard disk in the format of files or the like to distribute, in response to requests from many users, the requested contents to the respective users according to necessity.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the overall system including wireless terminals, base stations, and a server in which the present invention is applied to a wearable small-sized terminal;

FIG. 2A is a diagram showing an example of a communication path used when the wireless terminal or sensor node SN1 communicates with the sensor node SN2 in the radio topology shown in FIG. 1;

FIG. 2B is a diagram showing an example of a communication path used when the sensor node SN1 communicates via the relay node RN1 with the sensor node SN3 in the radio topology shown in FIG. 1;

FIG. 2C is a diagram showing an example of a communication path used when the sensor node SN1 communicates via the base station BS1 with the sensor node SN4 in the radio topology shown in FIG. 1;

FIG. 2D is a diagram showing an example of a communication path used when the sensor node SN1 communicates via the base stations BS1 and BS2 with the sensor node SN5 in the radio topology shown in FIG. 1;

FIG. 2E is a diagram showing an example of a communication path used when the sensor node SN1 communicates via the base station BS1, the intra-WAN relay node RN2, and the base station BS3 with the sensor node SN6 in the radio topology shown in FIG. 1;

FIG. 2F is a diagram showing an example of a communication path used when the sensor node SN1 communicates via the base station BS1 with the server SRV in the radio topology shown in FIG. 1;

FIG. 3A is a diagram showing an example of a front view of a sensor node SN1 of watch type according to the present invention;

FIG. 3B is a diagram showing an example of a bottom view of the sensor node SN1 of FIG. 3A;

FIG. 4A is a diagram showing an example of a top view of a sensor node SN2 of nameplate type according to the present invention;

FIG. 4B is a diagram showing an example of a rear view of the sensor node SN2 of FIG. 4A;

FIG. 5 is a block diagram showing an example of a general sensor node SN including a functional configuration commonly applicable to FIGS. 3 and 4;

FIG. 6 is a diagram showing an example of a data flow of an operation in which the sensor node SN receives a wireless packet having stored audio data and reproduces voice through a speaker;

FIG. 7 is a flowchart showing processing executed by a microprocessor when the sensor node SN receives a wireless packet having stored audio data;

FIG. 8 is a flowchart showing processing executed by the microprocessor when the sensor node SN reproduces the audio data;

FIG. 9 is a graph showing an example of the audio data and timing to reproduce the audio data when the sensor node reproduces the audio data;

FIG. 10A is a diagram showing an example of a payload layout of a wireless or radio packet having stored audio data, the packet being received by the sensor node SN;

FIG. 10B is a diagram showing an example of a payload layout of the wireless packet having stored audio data;

FIG. 10C is a diagram showing an example of a payload layout of the wireless packet having stored audio data;

FIG. 10D is a diagram showing an example of a payload layout of the wireless packet having stored audio data;

FIG. 11 is a graph showing an example of an input/output characteristic of a DA converter DAC;

FIG. 12 is a graph showing an example of a response characteristic with respect to time of the DA converter DAC when digital values 0x38, 0xBC, and 0x76 are inputted thereto at points of time T0, T1, and T2;

FIG. 13 is a graph showing an example of an output voltage characteristic with respect to time of the DA converter DAC when the reproduction data items of FIG. 9 are inputted thereto at the same points of timing;

FIG. 14 is a graph showing an example of an analog waveform obtained when the output voltage of FIG. 13 is passed through an output filter;

FIG. 15 is a diagram showing an example of a data flow when the sensor node SN conducts a sampling operation for the voice waveform obtained from a microphone and transmits a wireless packet having stored audio data;

FIG. 16 is a graph showing an example of an image of voice waveform sampling processing in a first embodiment of a sensor node on the transmission side;

FIG. 17 is a flowchart showing processing executed by a microprocessor in the first embodiment of a sensor node on the transmission side;

FIG. 18 is a graph showing an example of an image of voice waveform sampling processing in a second embodiment of a sensor node on the transmission side;

FIG. 19 is a flowchart showing processing executed by a microprocessor in the second embodiment of a sensor node on the transmission side;

FIG. 20 is a graph showing an example of an image of voice waveform sampling processing in a third embodiment of a sensor node on the transmission side; and

FIG. 21 is a flowchart showing processing executed by a microprocessor in the third embodiment of a sensor node on the transmission side.

### DETAILED DESCRIPTION OF THE PREFERRED EMBODIMENTS

Referring now to the drawings, description will be given of an embodiment of the present invention.

### First Embodiment

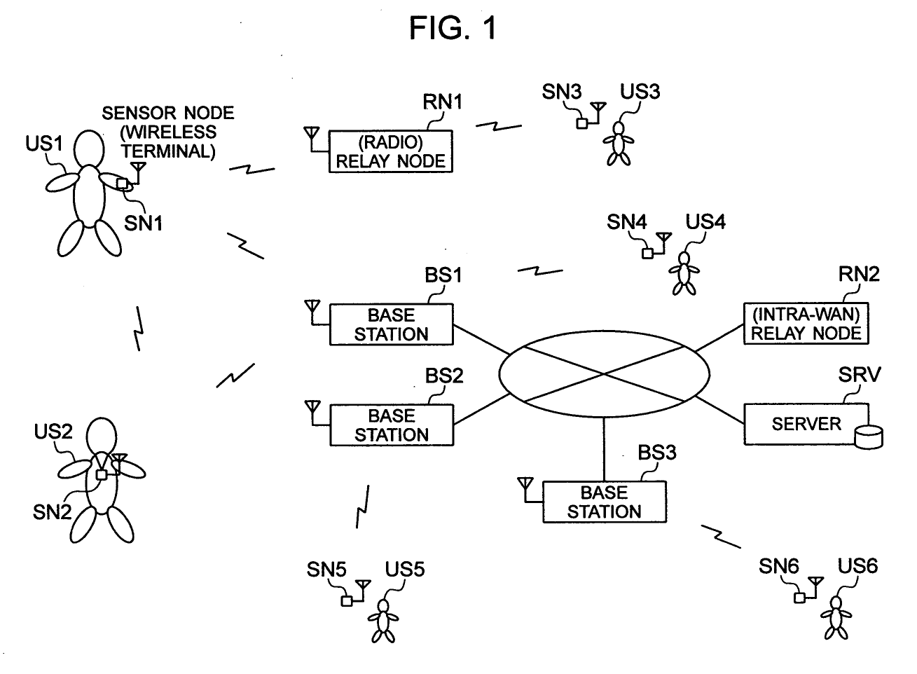

FIG. 1 shows an example of the system configuration including wireless terminals, base stations, and a server when the present invention is applied to a wearable small-sized wireless terminal.

A user US1 has a wireless terminal or sensor node of watch type SN1 including a speech function. The user US2 has a wireless terminal of nameplate type or name tag type SN2 including a speech function. Other users US3 to US6 respective have similar wireless terminals SN3 to SN6.

Each of the wireless terminals SN3 to SN6 is a small-sized wearable terminal of, for example, watch, nameplate, or name tag type, which can be attached to the user without causing any uncomfortableness or hindrance. It is at least desired that the terminal size is small, the cost thereof is reduced, and the terminal is driven by a battery for a long period of time. Therefore, it is suitable that the processing performance of the microprocessor and the memory capacity are lowered (i.e., are constructed according to lower specifications) in the wireless terminals when compared with conventional cellular phones, Personal Digital Assistants (PDA), and the like. Also for the wireless communication, it is desirable to employ a communication standard which facilitates the downsizing of the terminal and the reduction in the power consumption and the cost of the terminal. Therefore, the communication distance and the bit rate for communication are to be reduced as compared with the conventional cellular phones. The communication standard may be, for example, the ZigBee standard or the IEEE802.15.4 standard.

Each of the wireless terminals SN1 to SN6 includes a microphone and/or a speaker for the realtime or non-realtime call between the users US1 and US6. The wireless terminal is not only carried about by a human, but may also be a terminal to be fixedly disposed on a desk, a wall, a ceiling, or the like.

A radio relay node RN1 is a unit to wirelessly relay communication between wireless terminals which cannot directly communicate with each other, for example, because the terminals are apart more than about several tens of meters or are located in mutually different rooms. Similarly, the radio relay node RN1 is capable of wirelessly relay communication between the wireless terminal or sensor node (SN1 to SN6) and the base station (BS1 to BS3).

The base stations BS1 to BS3 are disposed to relay communication via a Wide Area Network (WAN) between the wireless terminals when the wireless communication is further interrupted due to, for example, the elongated distance between the terminals. The base stations BS1 to BS3 are also used to relay communication between a wireless terminal or a sensor node and a server connected to the WAN.

A server SRV includes an external storage and is a unit to communicate with a wireless terminal via the base station (BS1 to BS3) and/or an intra-WAN relay node RN2. The server SRV has a function to temporarily or permanently keeps audio or voice data sent from the sensor nodes SN1 to SN6 and to distribute the audio data or a beforehand-prepared voice message to the sensor nodes SN1 to SN6 in an on-demand mode.

The intra-WAN relay node RN2 is a unit to relay communication between the base stations BS1 to BS3 and the server SRV. In a large-sized system including, for example, several hundreds of wireless stations and base stations, the relay node RN2 serves a function to resolve a communication destination and to conduct priority control. However, in a system including about ten constituent components as shown in FIG. 1, the overall operation of the system may be smoothly conducted without using any intra-WAN relay node such as the relay node RN2.

The embodiment is suitably employed as a handsfree communication system in which a plurality of persons cooperatively carry out a job in an office or a factory by briefly conversing with each other. In an environment in which it is difficult for the users to converse by natural voices with each other because the users are at mutually different places or are apart from each other by more than several tens of meters, the embodiment makes it possible to realize a comfortable speech environment less expensive than that of the cellular phones and various wireless communication facilities for business use.

In FIG. 1, broken-line hooks indicate an example of topology between directly wirelessly communicable units in the sensor nodes SN1 to SN6, the radio relay node RN1, and the base stations BS1 to BS3. For example, while the sensor node SN1 is capable of directly communicating with SN2, RN1, and BS1; the sensor node SN6 is capable of directly communicating with only BS3. However, the radio topology dynamically varies according to movement or the users US1 to US6. The radio topology also varies not only by the physical movement of the users, but also by a change in the radio wave environment. When the ZigBee or IEEE802.15.4 standard is employed, such radio topology variation is automatically controlled by the standard without user's intervention.

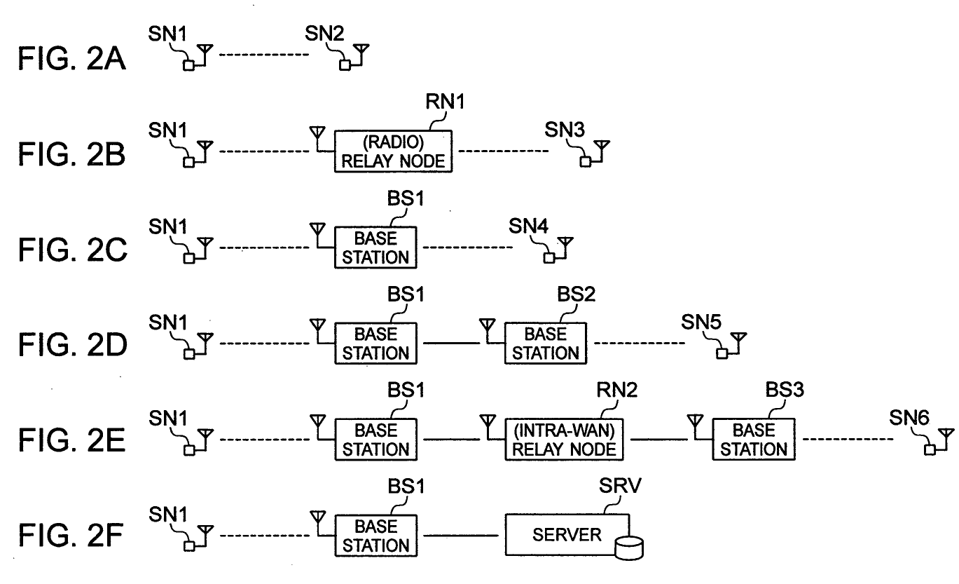

FIGS. 2A to 2F show examples of communication paths used when the sensor node SN1 communicates with the other units (sensor nodes SN2 to SN6 and the server SRV) in the radio topology shown in FIG. 1. In FIGS. 2A to 2F, a broken line indicates a radio communication section or interval conforming to a standard similar to that of the sensor nodes, and a solid line indicates a wired or wireless communication section in the wide area network.

The sensor nodes SN1 and SN2 have a positional relationship which allows direct communication therebetween. Therefore, as can be seen from FIG. 2A, the sensor nodes SN1 and SN2 can directly communicate with each other without using any relay node.

The sensor nodes SN3 and SN1 have a positional relationship which does not allow direct communication therebetween. Therefore, as FIG. 2B shows, the communication therebetween can be conducted via the radio relay node RN1 at a position which allows direct communication with the sensor nodes SN3 and SN1. Similarly, the communication between the sensor nodes SN1 and SN4 can be conducted via the base station BS1 as shown in FIG. 2C. More generally, more than one relay module, i.e., more than one radio relay node or one base station may be used for the communication. The communication between the sensor nodes at positions not allowing direct communication therebetween can be conducted via a plurality of radio relay nodes and/or base stations. This is called “multi-hop wireless communication” and has been applied to the communication method for mobile terminals and sensor networks.

The communication between the sensor nodes SN1 and SN5 cannot be achieved only by relays through radio communication intervals. However, the base station BS1 which is wirelessly communicable with SN1 can communicate via the WAN with the base station BS2 which is wirelessly communicable with SN2. Therefore, as FIG. 2D shows, the communication between the sensor nodes SN1 and SN5 is achievable via the base stations BS1 and BS2. Similarly, although the communication between the sensor nodes SN1 and SN5 is achievable via the base stations BS1 and BS3, it is also possible, as FIG. 2E shows, to implement the communication via the intra-WAN relay node RN2 controlling communication within the WAN.

As FIG. 2F shows, the communication between the sensor node SN1 and the server SRV is achievable via the base station BS1 which is at a position communicable with the sensor node 1 and which is connected to the WAN. It is also possible in this situation to further employ the relay node RN2 for the communication between the base station BS1 and the serve SRV as in the case shown in FIG. 2E.

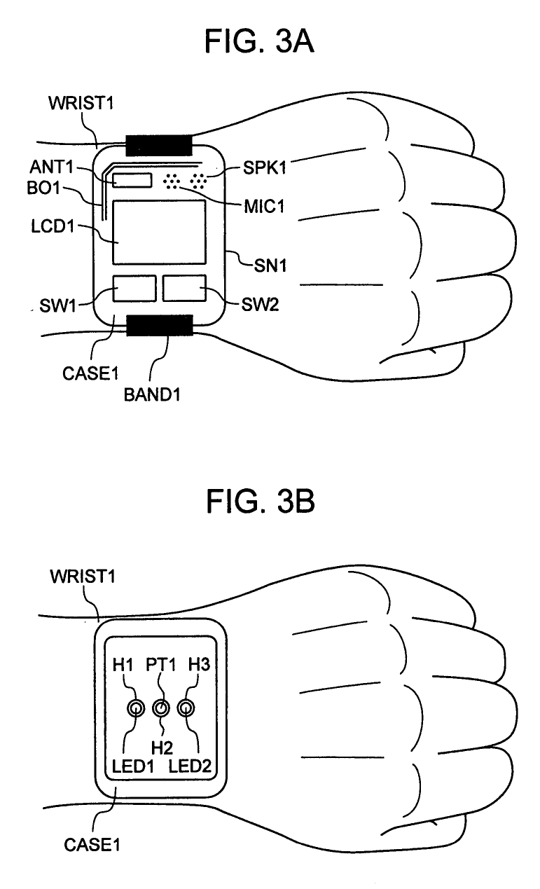

FIGS. 3A and 3B show a watch-type sensor node SN1 worn on the wrist (WRIST1) of the left hand of a human.

In FIG. 3A showing a front view of the sensor node SN1, a display LCD1 is disposed in a central area of a rectangular case CASE1 to display a message and the like. For example, a liquid-crystal display may be adopted as the display LCD1. On a first edge, i.e., an upper edge of CASE1 and a second edge, i.e., a lower edge thereof opposing the first edge, a band 1 is arranged to fix the sensor node SN1 on the wrist.

Between the band BAND1 on the lower end and the display LCD1 of the case CASE1, operation switches SW1 and SW2 are disposed on an inner board BO1 of the case CASE1 to be disposed on a surface thereof for the user of the terminal to operate the switches SW1 and SW2. For example, the switch SW1 is used to display a selection menu for call initiation, call reception, or the like to select desired items from the menu. The switch SW2 is then used to determine and to execute the menu selected using SW1 as above. These switches are representatively switches of push button type, but switches of other types are also available.

Between the band BAND1 on the upper end and the display LCD1 of CASE1, an antenna is disposed on the inner board BO1 of CASE1. The antenna ANT1 is, for example, a chip-type dielectric antenna using a high dielectric substance.

On the right-hand side of ANT1, two openings are disposed. At positions on the board BO1 of CASE1 respectively corresponding to the openings, a microphone MIC1 and a speaker SPK1 are disposed.

The sensor node SN1 may include a pulse sensor to measure the pulse of a human, a temperature sensor to measure the temperature of a human or the environmental temperature, a sensor to sense movement of the user (living body), or representatively an acceleration sensor. The present invention is not restricted by the acceleration sensor. Any sensor of another type is available if the sensor is capable of sense movement.

In FIG. 3B showing a bottom view of the sensor node SN1, a pulse sensor is disposed in the case CASE1. In the embodiment, the sensor includes an infrared ray emission diode and a phototransistor as a light receiving element. The light receiving element may be, in addition to a phototransistor, a photodiode. In three openings H1, H2, and H3 disposed on the bottom region of CASE1, a pair of infrared ray emission diodes (light emitting elements) LED1 and LED2 and a phototransistor (light receiving element) PT1 are disposed. These elements are disposed to oppose the skin of the user to thereby serve a function for a pulse sensor.

In operation of the pulse sensor, infrared rays generated from LED1 and LED2 are radiated onto a blood vessel. A change in intensity of scattered light from the blood vessel due to a variation in the blood flow rate is detected by the phototransistor PT1. On the basis of a period of the intensity change, it is possible to predict the pulse.

By applying the present invention to the watch-type wireless terminal of this kind, the user can suitably conduct a handsfree call without holding the terminal in hand as distinct from the telephone call which is conducted with the cellular phone in hand. When the user carries about the cellular phone, the cellular phone is usually placed in a pocket of the jacket of the user almost at any time. When it is required for the user to use the phone, the user conducts a sequence of operation steps, specifically, takes out the phone from the pocket and then changes the posture of the phone in the hands such that the phone opposes the face of the user to thereafter conduct operation. If the watch-type terminal is employed, it is not required to conduct the preparative operation in which the phone is taken out from the pocket and the posture of the phone is changed in hands such that the phone opposes the face of the user. That is, when it is required for the user to operate the phone, the user can conduct “one-touch operation” in which the user immediately starts the operation for his or her desired purpose without any preparative operation.

Also, it can be expected that the application of the present invention to the watch-type wireless terminal is more useful when compared with the prior art. Among the portable terminal devices, for the terminals for use in a mode in which the terminals are usually attached to the user to be carried about, it is particularly desired to reduce the terminal size and weight. If it is desired that such a small-sized terminal includes a high-performance speech function, there are inevitably required to use a microprocessor and a memory of high performance. The microprocessor and the memory are hence expensive, which leads to increase in the production cost of the terminal. That is, the terminal cannot be provided as an inexpensive product to be broadly sold in the market. In accordance with the present invention, there is provided a speech function of practical quality by use of a general inexpensive microprocessor and a general inexpensive memory which have low performance and which can be easily incorporated in the cellular phone.

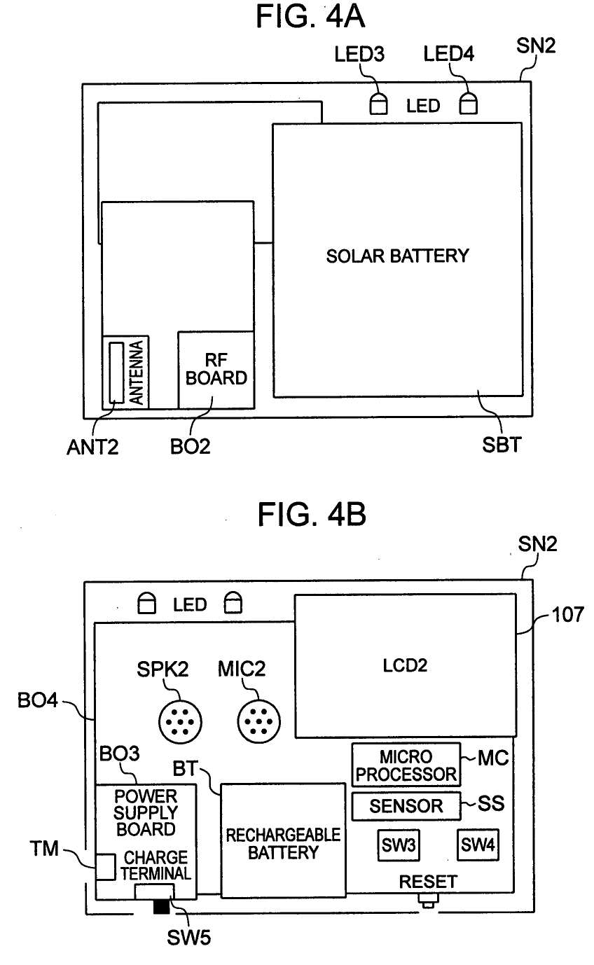

FIG. 4A shows a top view of a sensor node SN2 of nameplate type according to the present invention. FIG. 4B shows a rear view of the sensor node SN2.

By describing, for example, a name of the user on the surface of the nameplate-type sensor node SN2, it is possible to use SN2 as an ordinary nameplate. In use thereof, the user may hang the nameplate from the neck using a cord or a strap or may attach the nameplate on his or her jacket by, for example, a clip.

As FIG. 4A shows, on the surface of the sensor node SN2, there are disposed constituent elements as follows.

A solar battery SBT is a power supply module which converts energy of visible light into electric energy to thereby generate electric power. The sensor node SN2 may include, in place of the solar battery SBT, a power generating unit which generates power by use of vibration, temperature difference, or the like.

Light emission diodes LED3 and LED4 emit light under a predetermined condition. For example, by driving LED3 to emit light when the sensor node SN2 receives a notification of presence of audio data from one of the other terminals SN1, SN3 to SN6, and SRV, it is possible to notify presence or absence of a message to the user. By emitting light from LED4 when the power source voltage is lowered, it is possible to notify the user an event of insufficient battery power.

The Radio Frequency (RF) board BO2 is employed to mount thereon circuits required for wireless communication. The RF board BO2 wirelessly communicates via an antenna ANT2 with other devices such as SN1 and BS1. To avoid a disadvantage in which the solar battery SBT and the display LCD2 hinder the wireless communication, it is favorable that the antenna ANT2 s disposed at a position apart from SBT and LCD2.

As FIG. 4B shows, on the rear side of the sensor node SN2, there are disposed constituent elements as below.

The display LCD2 is a liquid-crystal display to display various information items. The terminal may include, in place of LCD2, a display of another type.

By operating the switch SW3, the user can input various information items to the sensor node SN2. BY operating the switch SW4, the user can conduct a changeover operation between “display” and “non-display” of LCD2 to thereby save power consumed by LCD2.

By operating a reset switch RESET, the user can reset the sensor node 2.

Two openings are disposed in a central area of the rear region of SN2. At positions on an inner board BO4 respectively corresponding to the openings, there are disposed a microphone MIC2 and a speaker SPK2.

A power switch SW5 is used to conduct a changeover operation between on and off of power of SN2.

A rechargeable battery BT supplies power to the sensor node SN2. In the battery BT, the charge current and voltage are rated and the discharge current and voltage are rated. In consideration of material of the battery BT, there is favorably employed, for example, a lithium-ion battery due to the large capacity per volume and no memory effect in the charging operation.

The rechargeable battery BT is charged when a charge terminal TM is connected to an external power source.

A power source board BO3 includes a diode LED, an overcharge preventive circuit, an over-discharge preventive circuit, a regulator, and a voltage divider circuit. For example, the board BO3 prevents overcharge and over-discharge of the battery BT and fixes the voltages supplied to the RF board BO2, a microprocessor MC, a sensor SS, the microphone MIC2, and the speaker SPK2 to respective predetermined values.

The microprocessor MC controls the operation of the sensor node SN2. For example, the microprocessor MC measures the voltage of the battery BT to predict the next charge time for the battery BT. The microprocessor MC also measures the voltage of the battery BT to set the sensor node SN2 to a power save mode for low power consumption if the voltage is low. Additionally, the microprocessor MC may be activated at a predetermined period or interval such that the microprocessor MC is in a sleep state in other than the activated state. This reduces power consumed by the microprocessor MC.

By disposing the display LCD2, the switches SW3 and SW4, the microphone MIC2, and the speaker SPK2 on the rear surface of the sensor node SN2, it is possible the sensor node SN2 is used as an information display terminal and a speech communication terminal for speech on the rear side while providing the function of the nameplate to the front surface. Particularly, in use of the terminal hung from the neck by use of a strap, when the user takes by hand the terminal with the strap, the rear surface of SN2 opposes the face of the user. It is therefore possible for the user to operate the SN2 placed in quite a natural posture as an information display terminal or a communication terminal. Disposing the modules on the rear surface enables to arrange a solar battery SBT having a large area on the front surface of SN2. That is, the solar battery SBT generates a larger amount of electric power. In the situation wherein a large-area solar battery SBT is disposed on the front surface of SN2, a transparent film on which the division or section and the name of the holder are described is favorably attached on the front surface of the battery SBT. Resultantly, while retaining the inherent function of the nameplate of SN2, the amount of power of SBT can be secured.

Also in the situation wherein the present invention is applied to the nameplate-type wireless terminal, as in the application of the present invention to the watch-type wireless terminal, the terminal is quite favorably used to conduct the handsfree call. Moreover, since it is highly desired to reduce the terminal in size, weight, and cost, the present invention is expectedly more useful in this situation as compared with the prior art. The nameplate-type or the name-tag-type wireless terminal is inevitably worn in the business scene in most cases. Therefore, by additionally disposing the information communicating function, particularly, the speech function to the conventional terminal, the terminal can be comfortably used in the business scene. In operation, after the user takes out the terminal from the pocket, the user is not required to conduct the operation to change the posture of the terminal, the operation being required when the cellular phone is used. It is therefore possible for the user to immediately conduct a telephone call or speech without feeling any stress.

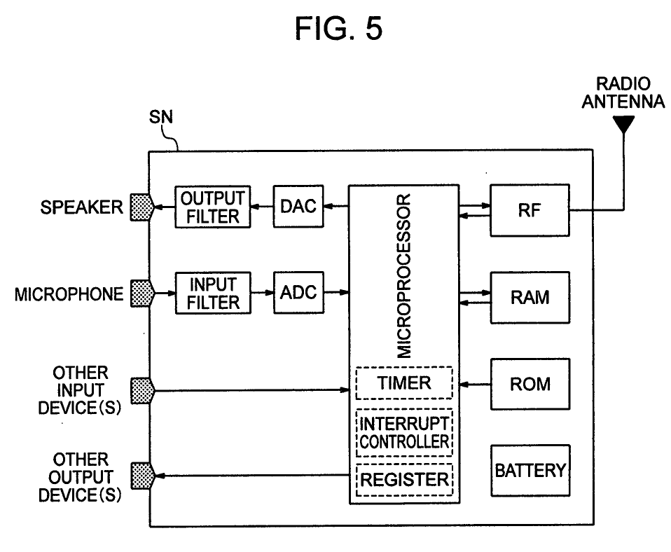

Although FIGS. 3A, 3B, 4A, and 4B show examples of implementation of the wireless terminal, the basic section of the implementation can be realized using a common functional configuration. FIG. 5 shows an example of a functional configuration commonly applicable to the examples shown in FIGS. 3A, 3B, 4A, and 4B. In the following description, the wireless terminal used to refer to the shared functional configuration will be referred to as “SN”.

The wireless terminal or sensor node SN includes a microprocessor to supervise the terminal SN. Processing to transmit an audio packet, processing to reproduce audio or voice signals, and processing to wirelessly transmit a packet are achieved through execution of a control program by the microprocessor. The microprocessor is a Large-Scale Integration (LSI) module including, in addition to the operation functions above, a timer function to measure a designated period of time, an interrupt function to wait for expiration of a period of time in the timer and occurrence of a predetermined external event, and registers to temporarily store data items. As the microprocessor, there may be adopted a general low-specification LSI module of a microprocessor which has an operation frequency of about several megaherz and which is adopted to be incorporated in an electronic appliances and units.

A Read Only Memory (ROM) is a nonvolatile memory to store a control program to be executed by the microprocessor and parameters to be referred to by the microprocessor during operation. The ROM may be, for example, a flash memory, or an Electronically Erasable and Programmable Read Only Memory (EEPROM). A Random Access Memory (RAM) is a readable and writable memory and is used as a temporary storage by the microprocessor to store, for example, a run-time variable, a packet, and audio data. The RAM may be a Static RAM (SRAM) or a Dynamic RAM (DRAM). In many cases, the ROM and the RAM are incorporated in the microprocessor.

To implement the wireless communication function, the sensor node SN includes a radio antenna and a radio-frequency section RF. The antenna converts a radio wave into an electric signal and vice versa. The wireless section RF converts or decodes an analog electric signal from the antenna into a wireless packet including digital data. Conversely, the wireless section RF converts or encodes a wireless packet including digital data into an analog electric signal.

The hardware to reproduce the audio or voice signal includes a speaker, an output filter, and a Digital-to-Analog Converter (DAC). The hardware to input and to conduct a sampling operation for the audio data includes a microphone, an input filter, and an Analog-to-Digital Converter (ADC). Details of the hardware and the control method thereof are essential to the present invention and hence will be described later.

Description will now be given of the respective blocks shown in FIG. 5 and a correspondence between FIG. 5 and FIGS. 3A, 3B, 4A, and 4B. While FIGS. 3A, 3B, 4A, and 4B show appearances of the wireless terminals in particular implementation examples, FIG. 5 shows internal functional structure of the wireless terminal and hence includes blocks not shown in FIGS. 3A, 3B, 4A, and 4B. If FIGS. 3A, 3B, 4A, and 4B include a block associated with a block of FIG. 1, the correspondence will be described. Otherwise, absence of the associated block will be noted.

In the configuration of FIGS. 3A and 3B, the microprocessor disposed in FIG. 5 is not shown. The microprocessor of FIG. 5 corresponds to the microprocessor in FIG. 4B. The ROM and the RAM disposed in FIG. 5 are not shown in FIGS. 3A, 3B, 4A, and 4B. The radio antenna of FIG. 5 corresponds to ANT1 of FIG. 3A and ANT2 of FIG. 4A. The wireless section RF of FIG. 5 is not shown in FIG. 3, but is shown as the RF board BO2 in FIG. 4A. The speaker of FIG. 5 is SPK1 in FIG. 3A and SPK2 in FIG. 4B. The microphone of FIG. 5 corresponds to MIC1 in FIG. 3A and MIC2 in FIG. 4B. The output filter, the DA converter DAC, the input filter, and the AD converter ADC are not shown in FIGS. 3A, 3B, 4A, and 4B.

The battery of FIG. 3 is not shown in FIGS. 3A and 3B, but is shown as the solar battery SBT and the rechargeable battery BT in FIGS. 4A and 4B. The other input devices of FIG. 5 are the operation buttons, the pulse sensor, and the like in FIGS. 3A, 3B, 4A, and 4B. The other output devices of FIG. 5 are the LED, the LCD, and the like in FIGS. 3A, 3B, 4A, and 4B. Similarly, the battery of FIG. 5 is the solar battery, a button cell, the rechargeable battery, or the like.

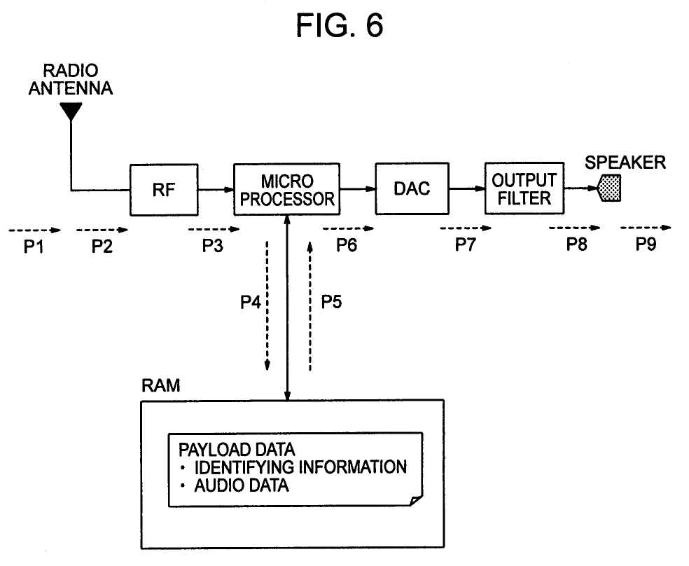

FIG. 6 shows a data flow of an operation in which the sensor node SN receives a radio packet having stored audio data and reproduces voice through a speaker.

The antenna receives a radio wave (P1). The radio wave is converted into an electric signal to be inputted to the radio section RF (P2). The radio section RF decodes the electric signal into digital data to create a packet data. According to necessity, there is executed protocol processing for the physical (PHY), Media Access Control (MAC), or the NetWorK (NWK) layer. The payload data of the packet is transferred to the microprocessor (P3) to be then stored in the RAM (P4).

The payload data includes identifying information and a sequence of audio data to be reproduced, which will be described later. In this specification, the identifying information is defined as information which prescribes or defines timing to reproduce the audio data sequence.

The microprocessor analyzes the identifying information to determine the timing to reproduce the audio data. According to the reproduction timing, the microprocessor sequentially reads a sequence of audio data from the RAM (P5) and outputs the data to the DA converter DAC (P6). The DA converter DAC converts the digital value inputted thereto into an analog voltage corresponding to the digital value. The analog voltage is inputted to the output filter (P7). A high-frequency component is removed from the analog voltage and then the voltage level thereof is converted, and the resultant voltage is outputted to the speaker (P8). The speaker generates voice and sound with vibrations associated with the time-series change in the voltage inputted thereto. This makes the sound and voice propagate through air (P9).

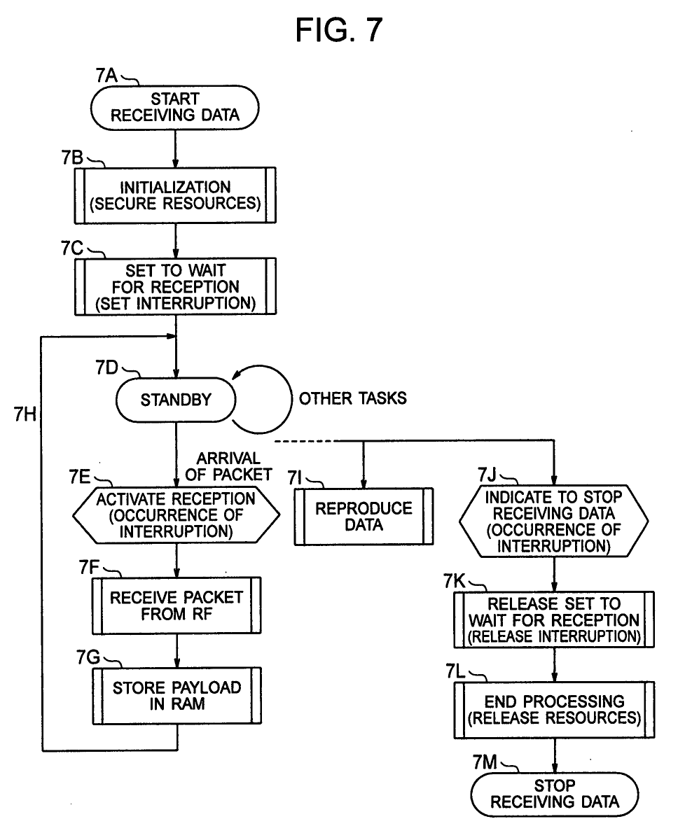

FIG. 7 shows a flow of processing executed by the microprocessor when the sensor node SN receives a wireless packet having stored audio data.

Steps 7A to 7H as well as associated states represent the basic flow to receive an audio data packet.

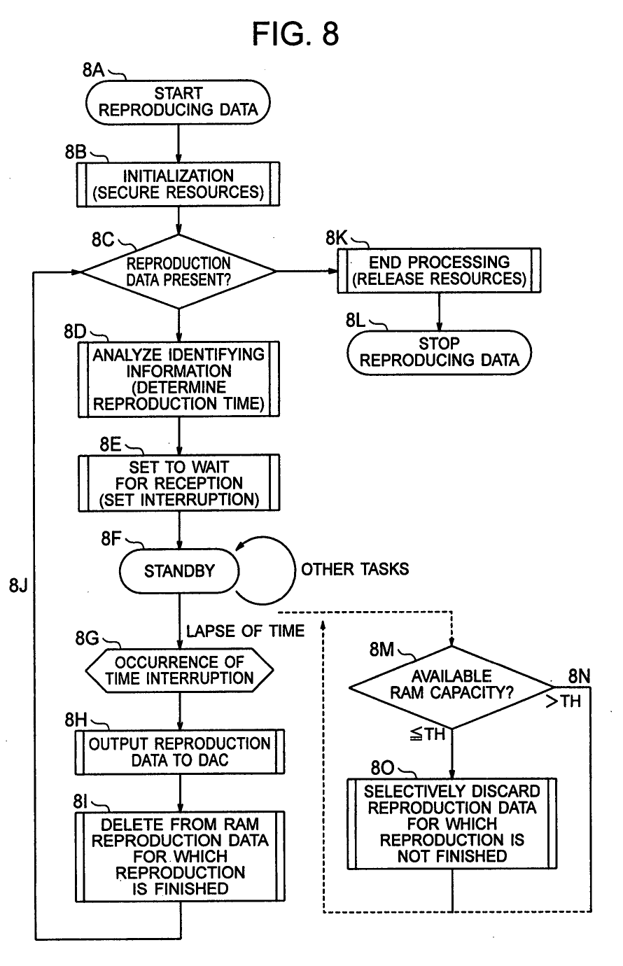

In response to, for example, a user's operation, a data receiving mode is activated (7A), and then an initialization step is conducted to receive data (7B). Specifically, the system secures hardware and software resources, for example, activates the radio section RF and reserves an area of the RAM to store data. Thereafter, an interruption is set to wait for reception (7C). Specifically, the system conducts a setting operation for the following purpose. When the radio section receives a radio wave and then generates packet data, an interruption signal is produced to interrupt the microprocessor. When the microprocessor receives the interruption signal, interruption processing is activated. Thereafter, the microprocessor enters a standby state (7D). In the standby state, the microprocessor waits for occurrence of the interruption set in step 7C and hence may execute other tasks or may set a sleep state. In FIG. 7, data reproduction processing (7I) is shown as an example of a task which the microprocessor can execute in the standby state (7D). FIG. 8 shows details of the data reproduction processing. In addition to the task shown in FIG. 7, there may be carried out, for example, processing to sense the pulse by the watch-type terminal SN1 and a menu operation by the user.

In the standby state 7D, regardless of a state in which another task is being executed or a sleep state, when a packet arrives, there occurs the interruption set in step 7C for the reception of a packet and hence the reception processing is initiated (7E). The packet is received from the radio section RF and the payload of the packet, i.e., the audio data is stored in the RAM (7G). After the reception processing is finished, the microprocessor again enters the standby state 7D to wait for a next packet (7H).

As above, the packet reception primarily includes a step to wait for the interruption for the packet reception in the standby state 7D and a step to activate the actual reception processing when the arrival of a packet is notified. In general, even in a state in which audio packets are being sequentially received, the packets are not necessarily transmitted completely in sequence with respect to time. That is, there exists an interval of time of about several tens of milliseconds between the packets.

On the other hand, since the microprocessor operates on the basis of an operation frequency of about several megaherz, the interval of time of about several tens of milliseconds is sufficiently long to execute other tasks. Additionally, since the number of operation steps required to process steps 7E to 7G is small, the processing is completely executed in about several milliseconds. That is, during the cycles of steps 7D to 7H, the microprocessor is in the standby state 7D in most of the period of time. In the standby state 7D, the power consumption can be reduced by setting the sleep state. However, it is possible in the embodiment to execute other tasks in the standby state 7D, and hence there is obtained an advantage similar to the multitask scheme supported by the operating system. Specifically, in the watch-type terminal SN1 shown in FIG. 3, without interrupting the periodic execution of the pulse sensing processing, the microprocessor can execute the packet reception processing and simultaneously can display on LCD1 a graph of a history of pulse values as a result of the pulse sensing processing. In the nameplate-type terminal SN2 shown in FIG. 4, while executing the packet reception processing, it is possible to simultaneously display on LCD2 a text-based browser-type menu in response to a user's operation of SW3 and SW4. Furthermore, if the communication band is available, it is possible to access the server SRV to obtain schedule information or the like.

Steps 7J to 7M are processing executed when the reception of audio data is stopped. In the standby state 7D, when it is indicated, for example, by a user's operation to stop reception of data, there occurs an interruption in the microprocessor corresponding to the reception stop indication (7J). At reception of the interruption, the microprocessor executes associated processing, namely, releases the setting of the reception wait interruption conducted in step 7C (7K) and releases the resources reserved in step 7B (7L). Thereafter, the microprocessor enters a state in which the data reception is stopped (7M).

The indication to start audio data reception (7A) and the indication to stop data reception (7J) may be explicitly activated by a user's operation or may be implicitly activated in cooperation with other processing. For example, after conducting the sampling of voice and the transmission of audio data in response to a user's operation, the reception start (7A) may be automatically activated to wait for a response from the communicating module. In many cases, the power consumption of the radio section RF occupies the most part of the power consumption of the sensor node SN due to a device characteristic of the radio section RF. Therefore, the battery is remarkably consumed if the sensor node SN is continuously activated in the reception wait state. It is consequently possible to conduct a control operation to reduce power consumption without deteriorating practicability. For example, the reception start (7A) and the reception stop (7J) are alternately activated by setting a timer. In a situation in which the nameplate-type sensor node SN2 is adopted for business use, the sensor node SN2 is expectedly powered by its solar battery. At the end of the business hours, it is expectable that the sensor node SN2 is connected to a charger to daily charge its rechargeable battery. It is not required for the user to strongly pay attention to the reduction in the available power. In a situation wherein the processing flow is applied to the sensor node SN2, it is also possible that the audio data reception start (7A) is automatically conducted when the system is activated. During the operation, the microprocessor may wait for the audio data reception in the standby state 7D even if the associated user's operation is not conducted.

FIG. 8 shows a flow of processing executed by the microprocessor when the sensor node SN reproduces the audio data.

When the data reproduction is started (8A), the microprocessor executes initialization processing for data reproduction (8B). Specifically, the microprocessor secures hardware and software resources, for example, starts supplying power to the speaker, initializes the DA converter (DAC), and reserves an area in the RAM. After confirming presence of the target data for reproduction in a predetermined area of the RAM (8C), the microprocessor analyzes the identifying information defining timing to reproduce the data and determines a point of reproduction time (8D). According to the identifying information, the microprocessor sets a timer interruption time (8E). The data layout of the identifying information will be described later in detail. In a situation of reproduction of natural voice of a human, the timer interruption time is on the order of several hundreds of microseconds. Thereafter, the microprocessor enters a standby state (8F). In the standby state 8F, it is possible that the microprocessor executes, while waiting for the timer interruption, other tasks and/or sets the sleep state. After a lapse of the period of time set as above, the timer interruption set in step 8E takes place (8G). The microprocessor reads the reproduction data from the RAM to output the data to the DA converter DAC (8H). The microprocessor then deletes the reproduction data from the RAM (8I) and returns to processing to confirm presence or absence of reproduction data (8J, 8C). In this way, so long as there exists reproduction data for reproduction, the microprocessor repeatedly executes the data reproduction processing in steps 8D to 8I. If absence of reproduction data is determined in the confirmation step 8C, the microprocessor executes reproduction end processing, namely, releases the resources secured in step 8B and then enters a state in which the reproduction processing is terminated (8L).

“The microprocessor then deletes the reproduction data from the RAM” in step 8I does not necessarily means that the associated RAM area is cleared to zeros. Depending on the system configuration, it may indicate processing “to release the associated RAM area”. Hereinbelow, “the microprocessor then deletes the reproduction data from the RAM” is to be understood in any case as above.

When the microprocessor is executing the data reproduction and another task at the same time, there likely occurs a situation in which the hardware resource allocatable to the audio reproduction is insufficient. In such situation, it is not necessarily required to reproduce all reproduction data received in the form of a packet. That is, the data may be selectively discarded for the data reproduction if the reproduction quality is not conspicuously reduced.

In FIG. 8, steps 8M to 8O representatively show processing to be executed when the free area of the RAM is insufficient. When the microprocessor is in the standby state 8F, a check is periodically made in a task other than the data reproduction processing, to determine the free area in the RAM (8M). If the free area is more than a predetermined threshold value TH, the ordinary processing is executed (8N). Otherwise, the reproduction data for which the reproduction has not been conducted is selectively discarded (8O) to continuously secure the necessary minimum area in the RAM.

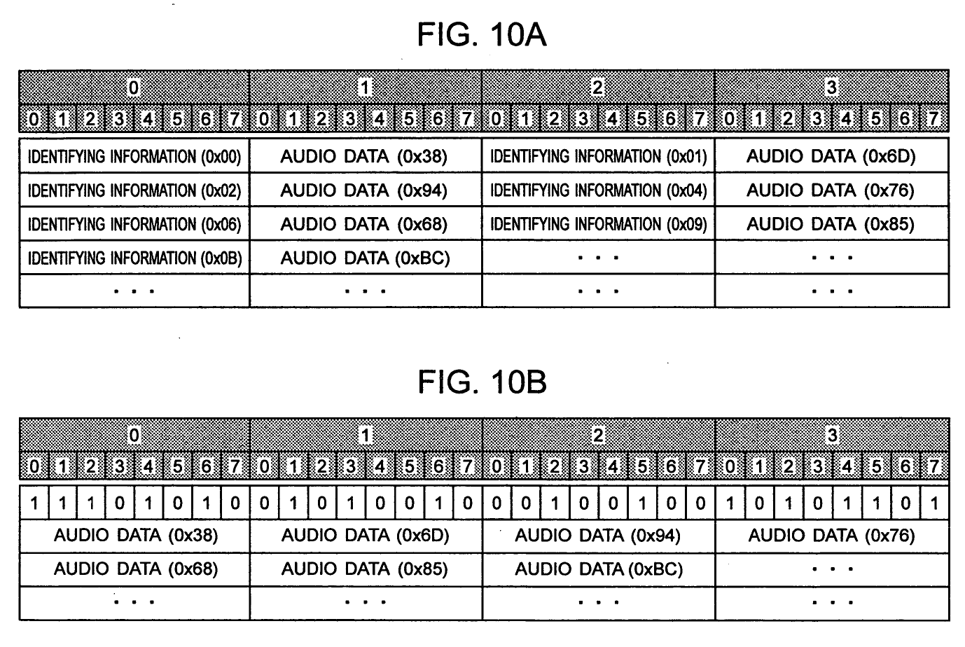

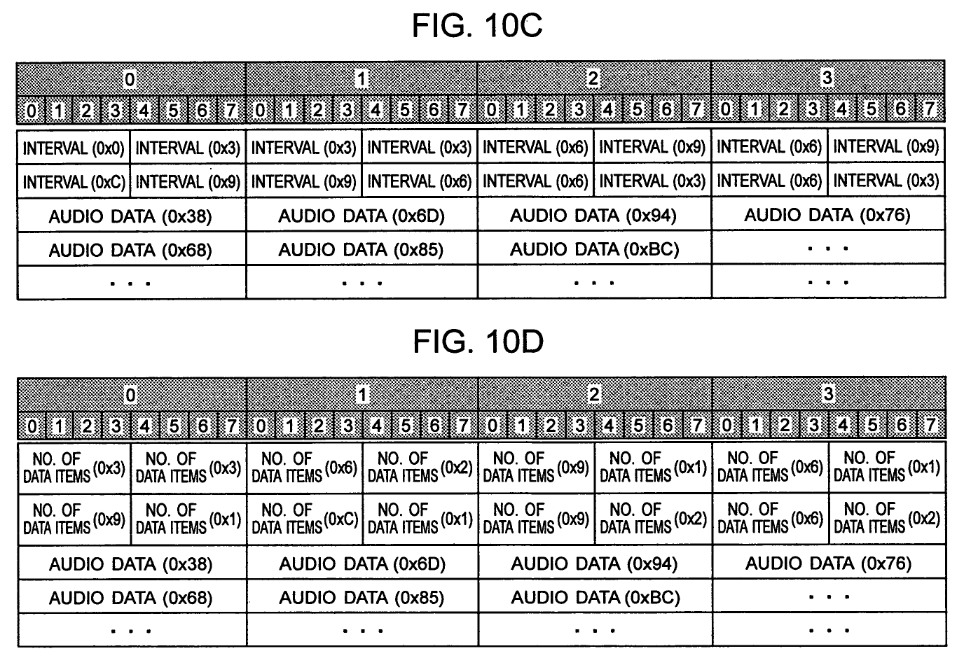

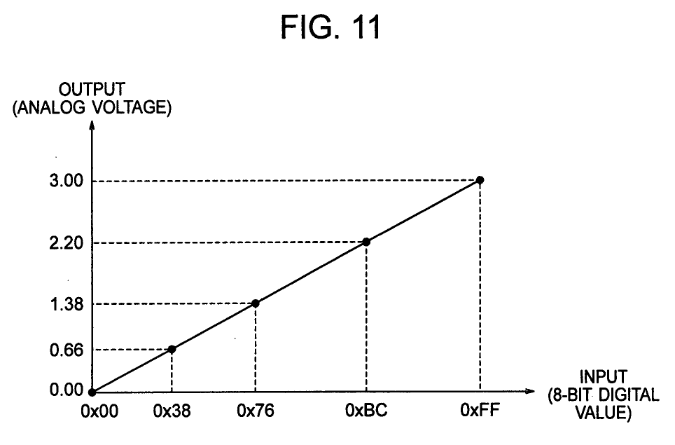

According to the present invention, the data reproduction timing is controlled on the basis of the identifying information shown in, for example, FIGS. 10A to 10D. Therefore, the processing described above is possible. Even when the reproduction data is selectively discarded, the basic data reproduction processing shown in steps 8A to 8J can be executed without any trouble only if the reproduction timing can be determined on the basis of the identifying information. By conducting the reproduction data discarding operation of step 80 according to an appropriate rule, the practical and lowest audio quality is guaranteed for the reproduced voice and sound while reducing the volume of data used for the actual data reproduction. A specific example of the data discarding rule in step 80 is equivalent to the rule in the first embodiment of a transmission-side terminal, which will be described later.

The entire audio data to be reproduced will be generally divided into many radio packets for communication thereof. There can be considered several points of timing to start the data reproduction processing (8A). For example, it is likely that the reproduction is started by a user's operation after all audio data items to be reproduced are received from another wireless terminal or the server SVR. Or, in a case wherein the wireless transmission route has a high data transmission rate capable of conducting realtime transmission of an audio stream, after reception of several packets, the packet data reproduction may be started in concurrence with the processing to receive subsequent packets. Step 7I of FIG. 7 briefly shows a relationship of such processing step to the other processing steps. In more detail, the standby state 7D of FIG. 7 is combined with the standby state 8F of FIG. 8, and the microprocessor waits for the packet reception interruption and the reproduction timer interruption.

In association with the preceding description, a relationship between the audio data size and the radio packet size will be described. In the radio communication field to which the present invention is primarily applied, the payload of the packet ranges from several tens of bytes to several hundreds of bytes. On the other hand, in a case in which the PCM encoding is used to conduct audio encoding with the similar speech quality as that of telephones, it can be considered that the quantization size is eight bits and the sampling frequency is eight kiloherz. Therefore, the size of audio data per second is 8000 bytes. According to the present invention, it is possible to implement an embodiment of the function to conduct data sampling and data transmission with high voice compression effect. In the embodiment with high voice compression effect, the audio data size can be lowered to “one over several tens” of that of the simple PCM encoding, which will be described later in detail. In a situation to transmit natural voice of a conversation, a group of audio data items takes a period of time ranging from about several seconds to about several tens of seconds. If the simple PCM encoding is carried out, the data is divided into packets, i.e., ranging from several hundreds of packets to several thousands of packets for communication thereof. On the other than, in the embodiment with high voice compression effect according to the present invention, the data is divided into packets ranging from several tens of packets to several hundreds of packets for communication thereof.

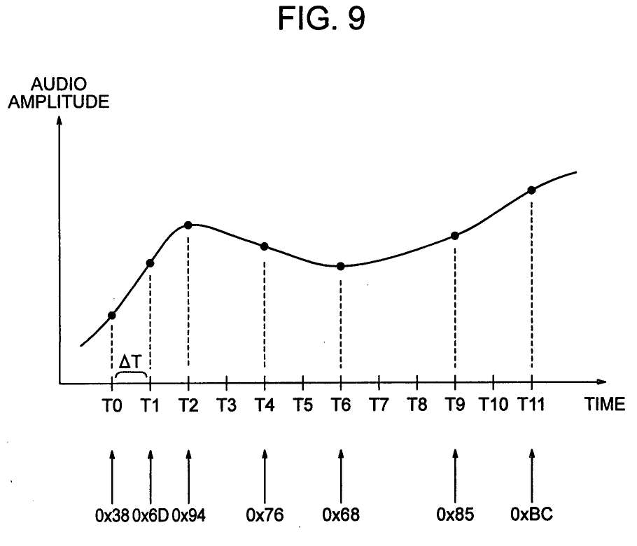

FIG. 9 shows audio data and timing to reproduce the audio data when the sensor node reproduces the audio data. In FIG. 9, points of time T0 to T11 represent a sequence of points of time when audio data encoded with a fixed sampling period is reproduced. Assume that the points of time are equally apart from each other by a fixed value ΔT. Also, assume that the audio data is actually reproduced at T0, T1, T2, T4, T6, T9, and T11. As described above, since it is assumed in the embodiment that the input data is data encoded with a arbitrary sampling period in time series, the points of time to actually reproduce voice and sound are designated, for example, as T0, T1, T2, T4, T6, T9, and T11.

Audio data to be reproduced at T0 is data 0x38 including eight bits encoded in advance. The digital value of audio data is similarly indicated for the other points of time. In FIG. 9, a black point is an ideal value of amplitude of the voice to be sounded by the speaker when the audio data is reproduced at the respective points of time. A curve drawn by smoothly linking these black points with each other is an ideal waveform of the voice and sound to be sounded by the speaker.

FIGS. 10A to 10D show examples of the payload layout of a wireless packet which has stored audio data and which is received by the sensor node SN. The payload layouts of FIGS. 10A to 10D show how the audio data values and the sequence of reproduction points of time shown in FIG. 9 are expressed. The data items with the respective payload layouts can be produced by a terminal on the transmission side, which will be described later. The present invention is not restricted by the audio data received by the sensor node SN, but is naturally applicable to data obtained by reading a recording medium having recorded data items in a payload layout like those of the embodiment.

FIG. 10A shows an example in which identifying information is assigned to each audio data. In the payload, the 0th byte stores identifying information 0x00 corresponding to the reproduction time T0 and the first byte stores an audio data value 0x38 to be reproduced at the reproduction time T0. In this way, identifying information corresponding to a point of reproduction time and an audio data value to be reproduced at the reproduction time T0 are sequentially stored in a field including two bytes.

Reproduction points of time T1, T2, T4, and so forth respectively indicated by the identifying information items 0x00, 0x02, 0x04, and so forth are respectively relative points of time T0+ΔT, T0+2ΔT, T0+4ΔT, and so forth relative to the reproduction start point of time T0.

Description will now be given of processing of the payload layouts according to the processing flow for the voice reproduction shown in FIG. 8. When presence of payload data is confirmed in step 8C, identifying information 0x00 is obtained from the 0th byte of the payload in step 8D. Although the reproduction start time T0 corresponding to the identifying information 0x00 may be designated by the transmission-side terminal regardless of the time at which the sampling is conducted by the transmission-side terminal, the reception-side terminal may also arbitrarily determine the reproduction start time T0. Moreover, the reception-side terminal may beforehand set a predetermined point of time. For example, by setting a buffering point of time for reproduction data in the timer interruption time setting step 8E corresponding to the identifying information 0x00, the data reproduction can be started in consideration of several seconds to be lapsed before part of the reproduction data is buffered. As a result, the system can cope with a situation wherein the input data is interrupted for several seconds. Furthermore, by setting the minimum available time in the timer interruption time setting 8E corresponding to the identifying information 0x00, the data reproduction can be carried out immediately after the reproduction processing of FIG. 8 is started. Incidentally, to start the data reproduction as soon as possible, the reproduction data may be outputted to the DA converter DAC (8H) by skipping steps 8D to 8G.

After the reproduction start time T0 is thus determined, the first byte “0x38” of the payload as the associated reproduction data is outputted to the DA converter DAC in step 8H. Thereafter, in the next reproduction cycle (8J), identifying information 0x01 is obtained from the second byte of the payload in step 8D. In this situation, to reproduce reproduction data 0x6D of the third byte of the payload at a relative point of time T0+ΔT, the reproduction time interval ΔT is set in the timer interruption setting step 8E. The processing procedure is repeatedly conducted for subsequent payload data items.

By use of the payload structure in which identifying information is assigned to each audio data, the microprocessor can execute the voice reproduction processing flow shown in FIG. 8 by use of simple processing to sequentially read the payload data of fixed size.

FIG. 10B shows an example of payload structure including an area to store identifying information, i.e., bit information defining the reproduction time interval of voice data on the basis of a bit gap and an area to store in time series the voice data to be outputted. Specifically, an area of 32 leading bits of the payload includes bit map information to conduct time-series re-allocation for the subsequent audio data sequence. If the n-th bit is ”1”, it is indicated that reproduction data is present at time Tn.

As FIG. 9 shows, the 0th, 1st, 2nd, 4th, 6th, 9th, and 11th bits are “1” corresponding to the sequence of points of time T0, T2, T4, T6, T9, and T11 for audio data reproduction. The fourth and subsequent bytes of the payload store actual reproduction data (0x38, 0x6D, 0x94, . . . ) in the reproduction order. The respective reproduction data items correspond to the points of time respectively associated with bits of “1” in the bit map information sequentially beginning at the first bit thereof. Therefore, the sensor node SN is capable of sequentially reproducing the reproduction data items according to the sequence of reproduction points of time T0, T2, T4, T6, T9, and T11 of the payload data.

Specifically, in step 8D of the voice reproduction processing flow shown in FIG. 8, 32 leading bits in the identifying information area are obtained from the payload. By scanning the bit map of the identifying information beginning at the first bit thereof, the timer interruption point of time is determined on the basis of the distance between the bits of “1”. For example, the identifying information for the reproduction data 0x94 is the second bit of the bit map and that for the next reproduction data 0x76 is the fourth bit of the bit map. The distance between the identifying information items is two bits. Therefore, in the reproduction cycle (8J) immediately after the reproduction of the reproduction data 0x94, a reproduction time interval 2×T is set in the timer interruption time setting step 8E for the reproduction of the next reproduction data 0x76.

The payload structure including the identifying information in the form of a bit map leads to an advantage that the data required for the identifying information is reduced in size and the audio data is efficiently transmitted using a restricted radio communication band.

FIG. 10C shows an example including information indicating an interval of time for the reproduction of an audio data sequence. In the example, an area of 64 leading bits of the payload are divided into four-bit areas to sequentially store information of the interval of time for the data reproduction. These information items sequentially indicate the order of the reproduction time intervals for the subsequent audio data sequence. In the example, the reference reproduction time interval ΔT is defined by a four-bit value “0x3”.

In specific processing for the payload structure, the first 64-bit area, i.e., the identifying information area of the payload is obtained at a time in step 8D of the audio reproduction processing flow shown in FIG. 8. For each group of four bits of the identifying information beginning at the first bit thereof, the timer interruption time is determined for the associated cycle. For example, the four leading bits (the 0th to 3rd bits) of the payload are the identifying information for the first reproduction data 0x38. Therefore, in the timer interruption time setting step 8E, a reproduction time interval of “0” is set. Or, by skipping steps 8D to 8G, the data is outputted to the DA converter DAC (8H). In the next cycle, the four subsequent bits, i.e., the 4th to 7th bits are the identifying information for the next reproduction data 0x6D. Therefore, based on the value 0x3, a reproduction time interval of ΔT is set in the setting step 8E. The processing is similarly executed also for the subsequent cycles.

In the payload structure of the example, the reproduction time interval is represented by four bits. Therefore, the payload structure represents 15 values for the reproduction time interval, i.e., 0x1 to 0xF excepting zero. Specifically, the reproduction time interval ΔT is defined by the four-bit value of 0x3. Therefore, if it is defined that each four-bit value is proportional to the actual reproduction time interval, the reproduction time interval representable by the payload structure can be expressed in a range from ⅓·ΔT to 5ΔT precisely in units of ⅓·ΔT. According to necessity, the correspondence between the four-bit values and the actual reproduction time intervals may be other than the proportional relationship. Therefore, by using the payload structure, it is possible to express reproduction data for which the sampling frequency quite flexibly varies. In the example shown in FIG. 9, the reproduction time interval takes only three values of ΔT, 2ΔT, and 3ΔT. That is, two bits are enough to express these values, and hence it is also possible to reduce the size of the payload area required for the identifying information to one half of that shown in FIG. 10C.

Although FIG. 10C shows an example in which the information of the reproduction time interval is disposed in a leading area of the payload, it is also possible as shown in FIG. 10A that a combination of a reproduction time interval and its associated audio data is sequentially stored in the payload.

FIG. 10D shows an example including a reproduction time interval between audio data items and the number of data items successive in time series which are to be reproduced according to the reproduction time interval. In this example, an area of 64 leading bits of the payload are divided into 8-bit areas in which four high-order bits represent a reproduction time interval and four low-order bits indicate the number of successive data items to be reproduced according to the reproduction time interval. These information items sequentially indicate the reproduction time intervals for the sequence of subsequent audio data items. Also in the example, as in FIG. 10C, the reference reproduction time interval ΔT is defined by the four-bit value “0x3”.

In the specific processing for the payload structure, the 64 leading bits are obtained at a time from the identifying information area of the payload. For each 8-bit area of the identifying information beginning at the first bit, the timer interruption time in the associated cycle and the number of cycles to set the interruption time are determined. For example, according to the identifying information in the 0th byte of the payload, the four high-order bits “0x3” indicate that the reproduction time interval is ΔT and the four low-order bits “0x3” indicate that the interval is effective for three cycles. Therefore, for three leading reproduction data items, i.e., in three reproduction cycles 0x38, 0x6D, and 0x94, the reproduction time interval ΔT is set in the timer interruption time setting step 8E. Similarly, according to the identifying information in the first byte of the payload, for two subsequent reproduction data items, i.e., in two reproduction cycles 0x76 and 0x68, the reproduction time interval 2ΔT is set in the setting step 8E.

The examples are quite suitable to express reproduction data including a set of time-series small sections having a common reproduction time interval. The example shown in FIG. 9 includes three types of small sections respectively having the reproduction time intervals ΔT, 2ΔT, and 3ΔT, and each of the small sections respectively includes at most served audio data items. In the case of this type payload structure, the longer the small section length is, the more the size required for the identifying information is reduced. Particularly, it is further favorable if the audio data includes audio data items in which the small section length is relatively large and each small section includes about several tens of audio data items. In this situation, by adopting a rule that one packet stores only one small section, the information of the number of reproduction data items is not required in the identifying information. By assigning, for example, one-byte information of an interval of time to each packet, the reproduction time can be controlled.

As above, the payload structure can be actually used in various modes. In any mode, it is common that the payload includes an audio data sequence to be reproduced and identifying information to determine timing at which each audio data item is reproduced.

When the present invention is applied to a small-sized wireless terminal, it is assumed that the data transfer rate of wireless communication is low, i.e., about several tens of Kilobits per second (Kbps). In general, in the wireless communication as distinct from the wired communication, the multiplexing with respect to space is impossible. Therefore the frequency band, particularly, the communication band itself is regarded as quite an important resource. It is hence favorable that the size of the identifying information is possibly reduced for the total amount of audio data items to be transmitted. However, the optimal payload structure cannot be uniquely determined. That is, the payload structure to be adopted varies depending on the characteristic of the audio data to be actually transmitted.

In the first and second embodiments of the transmission-side terminal, which will be described later, if the ratio of decimated or reduced intervals to all intervals is relatively small, the reproduction data sequence includes a set of small intervals represented in time series using a common reproduction time gap. It is therefore suitable to employ the example shown in FIGS. 10C or 10D. If the ratio of decimated or reduced intervals to all intervals is relatively large, the reproduction time interval of the reproduction data sequence arbitrarily varies in time series, and hence it will be favorable to use the example shown in FIG. 10B. Similarly, also in the third embodiment of the transmission-side terminal, which will be described later, it will be favorable to use the example shown in FIGS. 10B, 10C, or 10D although depending on the value of the threshold employed in the processing.

Although there have been devised DA converters of various principles and characteristics, the DA converter employed in this embodiment is a DA converter which is generally and broadly used and which is called a DA converter of ladder resistor type. In conjunction with the embodiment, description will be given of an example in which a DA converter of ladder resistor type is employed.

It is assumed in FIGS. 5 and 6 that the DA converter DAC receives an input including an 8-bit digital value and produces an output including an analog voltage ranging from zero volt to three volt. FIG. 11 is a graph showing an example of an input/output characteristic of the DA converter DAC. The characteristic is represented by expression (1) in which the number of significant digits is three.

Output voltage (volt)=3.00×Input value (converted into decimal notation)/256.00 (1)

According to FIG. 11 and expression (1), the DA converter DAC has a linear output characteristic corresponding to the input value. That is, if 0x00 (0.00 in decimal notation) is inputted to the converter DAC, 0.00 volt is outputted therefrom, and if 0xFF (256.00 in decimal notation) is inputted to DAC, 3.00 volt is outputted therefrom. If the input value increases 0x01, the output value increases about 0.012 volt.

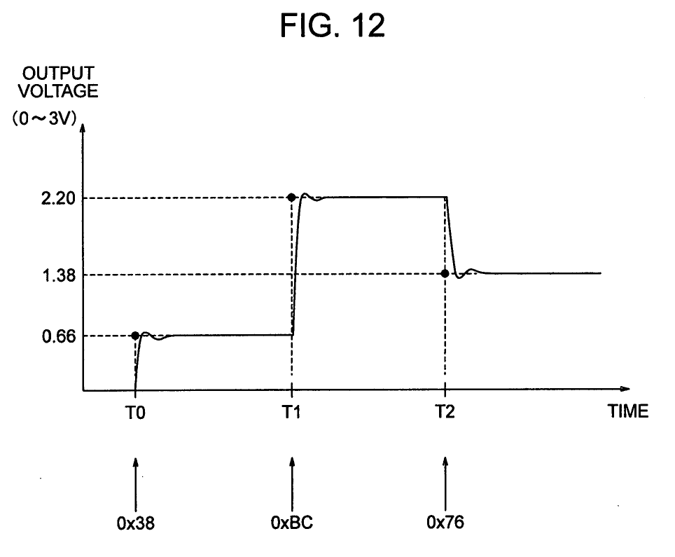

Description will now be given of the response characteristic with respect to time of the DA converter DAC. FIG. 12 shows the response characteristic of the converter DAC when digital values 0x38, 0xBC, and 0x76 are inputted thereto at points of time T0, T1, and T2. Assume that the output is 0.0 volt in the initial state before the time T0. When the digital value 0x38 is inputted to DAC at T0, the output analog voltage quickly varies from 0.0 volt to 0.66 volt corresponding to the input value 0x38. Thereafter, until the next input operation is conducted at T1, the output value is kept at 0.66 volt. When the digital value 0xBC is inputted to DAC at T1, the output analog voltage quickly varies from 0.66 volt to 2.20 volt corresponding to the input value 0xBC. Thereafter, until the next input operation is conducted at T2, the output value is kept at 2.20 volt. Similarly, when the digital value 0x76 is inputted to DAC at T2, the output analog voltage quickly varies from 2.20 volt to 1.38 volt corresponding to the input value 0x76. The output value is kept unchanged until the next input is received by the DA converter DAC.

When a digital value is received, the circuit connection is changed by a switching unit in the DA converter DAC. In FIG. 12, an ideal response characteristic with respect to time of the converter DAC is indicated by a step-formed line linking black points with each other. Actually, however, quite a short period of time is required as a period of transient response time from when the switching takes place to when the output signal becomes a designed output value in a stable state. The transient response time is about several tens of nanoseconds for an ordinary DA converter. In the embodiment in which the voice is reproduced, the input cycle for the DA converter DAC is at most several tens of kiloherz. Therefore, at least several tens of microseconds lapse from when a value is inputted to the DAC to when a subsequent value is inputted thereto. That is, the duty ratio during the period of transient response time is about 0.1 percent, which is a negligible level in practical use.

As FIG. 12 shows, the general DA converter holds, so long as the converter is being supplied with driving power, an output level associated with a previous input until a subsequent input is inputted thereto. In the embodiment, the input interval for the DA converter is variable. Herein, for the voice which corresponding to reproduction frequencies of at most about several tens of kiloherz, to vary the input interval in a range from several times to one-severalth of the reference interval works properly, without particularly paying attention to the upper limit of the driving frequency in consideration of the transient response. As for performance of a microprocessor to control the input interval, an inexpensive microprocessor which is to be incorporated in electrical or electronic appliances and which has an operation frequency of about several megaherz is capable of controlling the input interval of data fed to the DA converter DAC on the order of microseconds.

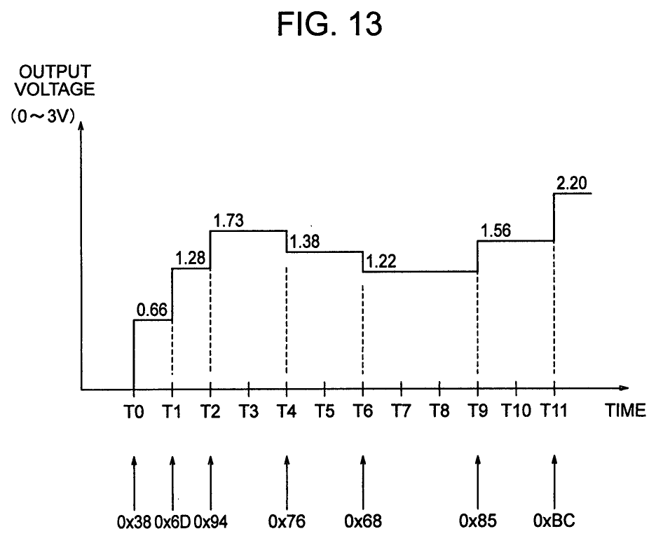

FIG. 13 shows an example of the output voltage characteristic with respect to time of the DA converter DAC when the reproduction data items of FIG. 9 are inputted thereto at the same points of timing. Strictly speaking, although there occurs a transient response similar to that shown in FIG. 12, since the timescale of the transient response is negligible in practical use, it is assumed that the waveform shown in FIG. 13 is an ideal stepped-form output waveform.

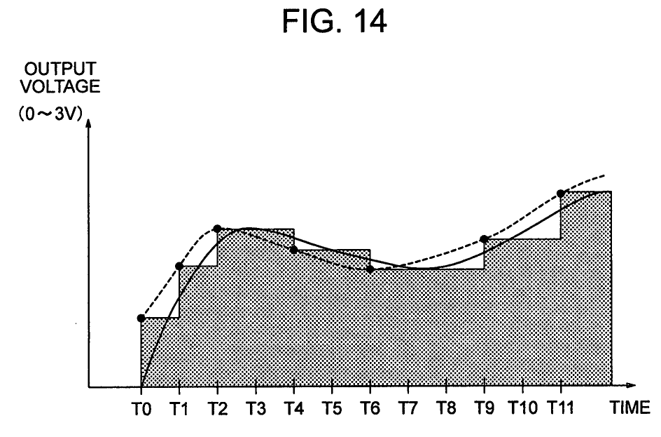

The output waveform of FIG. 13 is passed through the output filter to be converted into a smooth analog waveform as indicated by a solid line in FIG. 14. The smooth analog waveform is inputted to the speaker. The output filter smoothes the stepped-form output waveform from the DA converter DAC to remove high-frequency noise. The output filter may include a simple integrating circuit using a capacitor or may be, for example, a sample-and-hold circuit to improve the response characteristic. In general, the smoothed waveform outputted from the output filter is slightly different from the ideal waveform indicated by a dotted line. There is obtained an output waveform slightly delayed with respect to time in association with the smoothing coefficient. However, the delay is at most on the order of the reference frequency and hence is not recognized as deterioration in the reproduced sound in an ordinary application.

Although not particularly shown in the drawings, the output filter may include an amplifying function which amplifies the output voltage and which conducts a level conversion for the output voltage to conform to the output characteristic of the speaker. It is also possible that the circuit of the output filter is separated from that of the amplifier.

Description has been given in detail of the embodiment associated with the function in which a radio packet is received to reproduce audio data. Description will next be given in detail of an embodiment associated with a function in which a sampling operation is conducted for the audio data to transmit a radio packet.

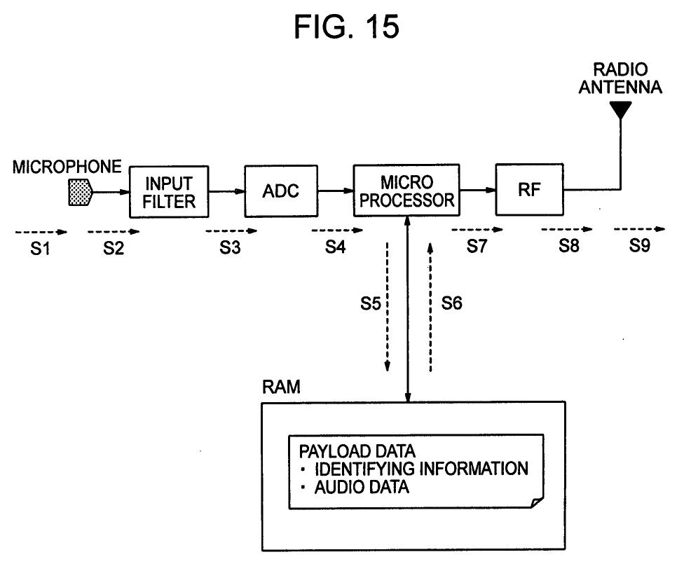

FIG. 15 shows a data flow when the sensor node SN conducts a sampling operation for the voice waveform obtained from the microphone and transmits a wireless packet having stored audio data.

Voice propagating as vibration of air (S1) is received by a microphone to be converted into an electric signal, which is inputted to an input filter (S2). A high-frequency component is removed from the signal and the voltage level thereof is converted, and then the signal is inputted to an AD converter ADC (S3). The converter ADC converts the analog voltage into digital value corresponding thereto. The digital value is transferred to the microprocessor (S4). The microprocessor creates identifying information indicating timing to reproduce the digital value in time series to store the identifying information together with the digital value (S5). These information items are contained as the payload data of the radio packet. At predetermined timing, the microprocessor creates packet data having stored the payload data (S6) and inputs the packet data to a radio section RF (S7). The radio section RF encodes the packet data into an analog electric signal to deliver the analog signal to a radio antenna (S8). The antenna converts the electric signal into a radio wave to propagate the radio wave through air (S9).

The packet data sent from the response node SN includes the audio data sequence to be reproduced and the identifying information indicating timing to reproduce audio data in time series. As described above, the payload may be specifically constructed as shown in FIGS. 10A to 10D. The sensor node SN having received the packet can appropriately control, according to the embodiments of the packet reception and the audio reproduction, the reproduction timing based on the identifying information. That is, when the response node SN conducts a sampling operation for the audio data to transmit audio data, the audio data and the identifying information are stored in the packet of the predetermined format and then the packet is transmitted. It is hence not required to assume as in the prior art that the audio data is associated with a fixed sampling rate. The present invention is applicable to data for which the sampling rate for the data reproduction arbitrarily varies with respect to time.

For easy understanding of the following description, several terms will be defined.

In operation in which the sensor node SN conducts a sampling operation for voice, stores the audio data and the identifying information in a radio packet, and then transmits the packet therefrom according to the data flow shown in FIG. 15, the sensor node SN will be referred to as “transmission-side terminal”. On the other hand, in operation of the sensor node SN in which the radio packet having stored the audio data and the identifying information are received to reproduce the voice according to the data flow shown in FIG. 6, the sensor node SN will be referred to as “reception-side terminal”.

In the operation of the transmission-side terminal, processing in which the microprocessor obtains digital data from the AD converter ADC according to the data flow shown in FIG. 15 will be referred to as “base sampling”. A frequency corresponding to an execution period of the base sampling will be called “base sampling frequency”. In the embodiment, it is not necessarily required that the audio data transmitted as a radio packet from the transmission-side terminal contains all audio data items obtained through the base sampling. It is also possible that audio data items to be transmitted are selectively discarded according to a predetermined rule and the identifying information indicating the reproduction timing is appropriately assigned to audio data items selected as a result of the discarding operation. As a result, only part of the data obtained through the base sampling is contained in the radio packet to be transmitted. Processing to create the actual audio data to be transmitted as the radio packet will be referred to as “effective sampling”.

Description will now be given of aspects of the present invention using the terms defined above. The transmission-side terminal creates, on the basis of the audio data obtained through the base sampling, the effective sampling data and the identifying information indicating timing to reproduce the effective sampling data, stores the data and the identifying information in a radio packet, and then transmits the packet therefrom. The reception-side terminal controls, on the basis of the identifying information extracted from the data sent from the transmission-side terminal, the timing to output reproduction data to the DA converter DAC.

It is a general practice in the prior art that the amount of audio data items is reduced by applying a data compression algorithm and a data reproduction algorithm to restore or to interpolate data to be reproduced. However, it is assumed in the prior art to use data of a fixed sampling frequency such as data of the PCM format at the input and output points of time on the device levels of the AD converter and the DA converter. That is, consideration has not been given to a variable input interval mainly for the following reasons. In the conventional industrial applications, it is not required to adopt a variable input interval. Also, the prior art has not developed industrial applications requiring a variable input interval. Particularly, in the data reproduction, regardless of the data format employed at data transmission, the data is shaped into data of a fixed frequency by executing processing such as restoration or interpolation and then the data is inputted to the DA converter at a fixed period.

On the other hand, regardless of the frequency variation characteristic of the data to be reproduced, by desirably controlling the timing to input data in the DA converter of the reception-side terminal, the processing to restore or to interpolate data can be dispensed with. It is hence possible to reproduce the data with the frequency variation characteristic kept unchanged. Resultantly, the reproduction performance of the reception-side terminal is remarkably improved. Also, the transmission-side terminal can create, without being influenced by the restriction of the reproduction performance of the reception-side terminal, the effective sampling data with a large degree of freedom. That is, it is possible that the transmission-side terminal creates data of a variable sampling rate in which the frequency of the effective sampling data discretely or successively varies in time series and then sends the data to the reception-side terminal. It is also possible that the effective sampling rate is quite flexibly adjusted in association with variations with respect to time in the processing load on the microprocessor, the free area of the RAM, and the radio communication quality. That is, while the states of resources are varying from time to time, it is possible to transmit audio data with optimal quality, the audio data being transmissible in such environment. Even such data is received, the reception-side terminal desirably controls the timing to input data to the DA converter according to the identifying information indicating the timing for the data reproduction to thereby appropriately reproduce the data.

According to the present invention, in the transmission-side terminal, while the base sampling data is ideally transmitted therefrom, the method to create the effective sampling data is appropriately modified to resultantly implement a function to adjust the sound quality according to resources and a function to compress audio data with high quality. Description will next be given of embodiments of a method of controlling the transmission-side terminal.

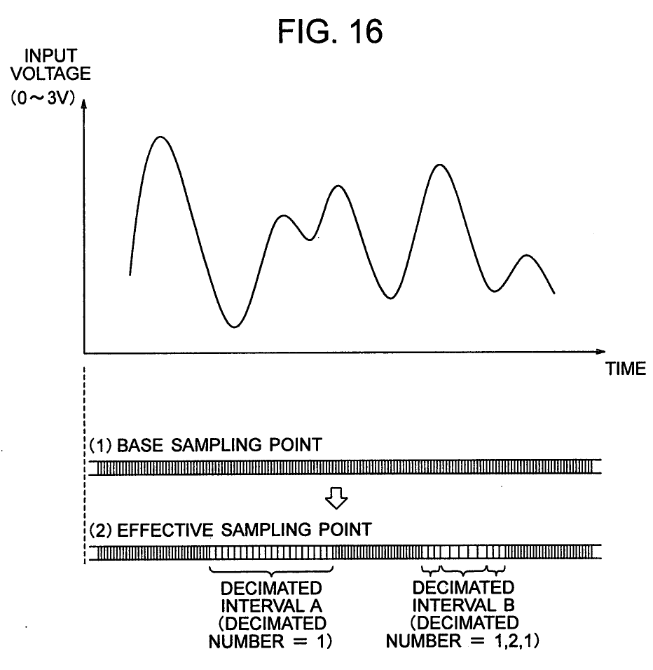

FIG. 16 shows an image of the voice waveform sampling processing in a first embodiment of the transmission-side terminal.

FIG. 16 shows in the upper section thereof an example of an input waveform S3 to the AD converter ADC. It is assumed that the input voltage value ranges from zero volt to three volt, which corresponds to the range of the output voltage value from the DA converter DAC. This condition is assumed only for convenience of description of the embodiment, and hence the range of the input voltage to ADC may differ from that of the output voltage value from DAC.

The lower section of FIG. 16 shows sequences of sampling time along the same time axis as for the input waveform S3. Points shown in (1) of FIG. 16 are base sampling points, which is a sequence of points of time; specifically, the microprocessor actually obtains digital values as a result of the sampling operation by the AD converter ADC and then stores the digital values in the RAM together with identifying information associated therewith according to the sequence of points of time.

In the embodiment, the base sampling points have a fixed sampling period and hence the interval between the sampling points of time is fixed. On the other hand, points shown in (2) of FIG. 16 are effective sampling points, which are created by selectively discarding the base sampling points according to a data discarding ratio determined by a predetermined rule. Audio data and identifying information corresponding to the selected base sampling points are stored in a radio packet for transmission thereof. A decimated interval A is an interval obtained by selecting every second base sampling points. A decimated interval B includes three sub-intervals, i.e., first, second, and third sub-intervals. The first sub-interval is obtained by selecting every second sub sampling points. The second sub-interval is obtained by selecting every third sub sampling points. The third sub-interval is obtained by selecting every second sub sampling points. In this way, there is created and is transmitted audio data for which the effective sampling period varies with respect time.

To retain the sound quality, it is ideal to transmit data at the base sampling points without decimation. However, if the radio communication rate cannot be sufficiently secured due to, for example, a deteriorated radio communication environment, sampling data waiting for transmission thereof is sequentially buffered in the RAM. If it is attempted to transmit the data at the base sampling points in this situation, a large-capacity RAM is required to be disposed in the sensor node SN. Or, if the RAM capacity is insufficient, there inevitably occurs an event of buffer overflow.

In the embodiment, when the free area of the RAM is lowered in such situation, the sampling data stored in the RAM is selectively discarded as in the decimated intervals A and B. This leads to an advantage that the free area of the RAM is secured and the buffer overflow is prevented. In the operation, data is discarded neither in a random way nor in a batch. The data is discarded with a predetermined interval therebetween. It is hence possible to guarantee the minimum required sound quality also in the decimated intervals. For example, if the base sampling frequency is 18 kiloherz, the effective sampling frequency is nine kiloherz in the decimated interval A and the effective sampling frequency is six kiloherz in the decimated interval B. Although the reproduction quality is slightly lowered, it is resultantly possible to secure the reproduction quality almost sufficient to transmit voice of a conversation. According to the embodiment, by selectively discarding sampling data according to the state of the RAM of the terminal, it is possible to provide a sound quality adjusting function associated with resources of the terminal.

In the procedure of the embodiment, the data of base sampling points are once stored in the RAM and then data of the effective sampling points are selectively discarded before the data is actually transmitted in the form of a radio packet. The embodiment is highly adaptable to a situation in which the RAM capacity of the sensor node SN includes a sufficient marginal area and a predetermined time difference is allowed between the base sampling operation and the transmission of the radio packet. This situation often appears in an on-demand audio transmission having a relatively low-level request for the realtime operation. The audio transmission of on-demand type has an advantage that even when the radio communication rate is less than the rate required for the realtime transmission, it is possible to transmit and to reproduce the audio signal by buffering the signals on the transmission side and the reception side.

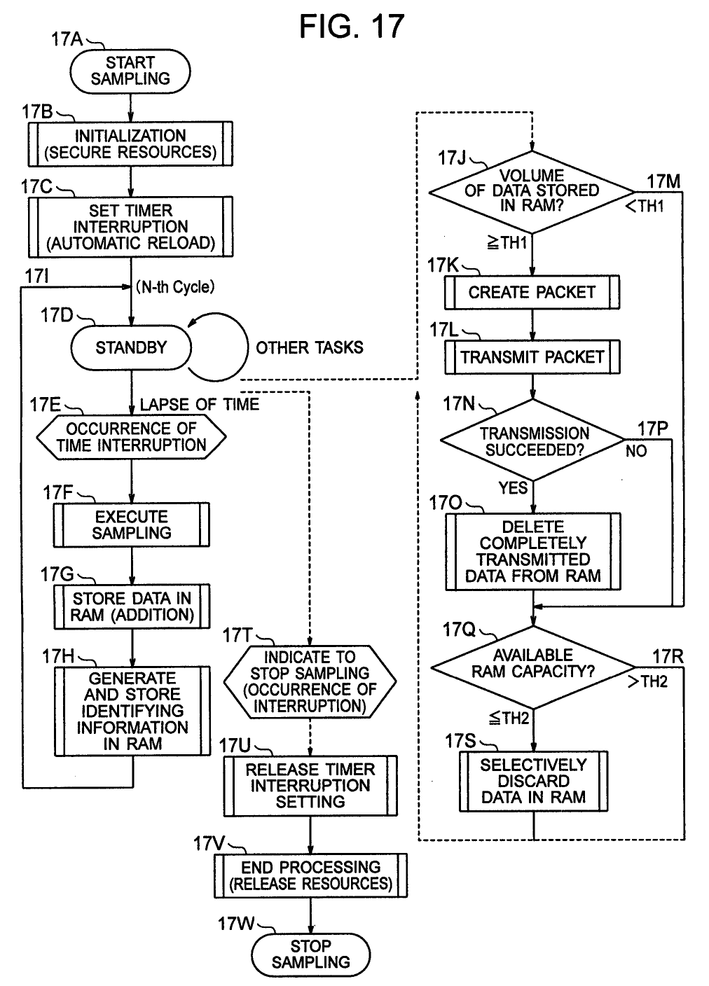

FIG. 17 shows an example of processing executed by the microprocessor in the first embodiment of the transmission-side terminal.

The processing flow of FIG. 17 includes base sampling processing indicated by steps 17A to 17I, radio packet transmission processing indicated by steps 17J to 17P, effective sampling data creation processing indicated by steps 17Q to 17S, and sampling stop processing indicated by steps 17T to 17W.

When the sampling processing is started in response to, for example, a user's operation (17A), initialization processing is executed (17B). Specifically, hardware and software resources are secured, for example, the AD converter ADC is initialized, an area is reserved in the RAM to store data, and the radio section RF is activated. Thereafter, a timer interruption is set to conduct the base sampling (17C). In the embodiment, the base sampling is executed with a fixed period beforehand determined. It is hence favorable to set “auto-reload” in the step 17C in which the interruption repeatedly occurs at an interval of time set as a period of timeout. The microprocessor enters a standby state (17D). In this state, while waiting for the timer interruption, the microprocessor may execute another task or may set a sleep state. At occurrence of the timer interruption set in step 17C, the microprocessor executes the sampling processing to obtain a digital value corresponding to analog audio data from the AD converter ADC (17F). The microprocessor stores the digital value in the RAM (17G) and creates identifying information for the digital value to store the identifying information also in the RAM (17H). The microprocessor enters a standby state 17D to wait for arrival of the next sampling time (17I). The microprocessor reads reproduction data from the RAM to output the data to the converter DAC (8H).

Each time the microprocessor enters the standby state 17D, a check is made by another task to determine the amount of data stored in the RAM. According to necessity, the microprocessor executes processing to transmit a radio packet or to reduce the audio data. First, the microprocessor checks the amount of audio data stored in the RAM (17J). If the amount is equal to or more than a predetermined threshold value TH1, the microprocessor executes processing to create a radio packet (17K) and processing to transmit the packet (17L). Otherwise, the packet creation and the packet transmission are not conducted (17M). The processing to transmit the packet is successfully conducted or fails depending on the radio communication environment at the point of time. For example, the packet transmission processing fails in a case wherein other terminals are in communication and the period of time in which the pertinent terminal cannot conduct the packet transmission continues at least a predetermined period of time or in a case wherein a reception response packet cannot be received from the reception-side terminal due to, for example, deterioration in the radio communication environment even after the retry is repeatedly conducted for the reception response packet predetermined times.

When the result of the transmission is confirmed (17N). If it is determined that the transmission is successfully conducted, the microprocessor deletes from the RAM the audio data and the identifying information for which the transmission is finished (17O). If the transmission fails, the packet data is required for the retry of the transmission and hence is kept retained in the RAM (17P).

The microprocessor then makes a check to determine the free area of the RAM to store subsequent audio data and its identifying information (17Q). If the free area is more than a predetermined threshold value TH2, the microprocessor does not take any particular action (17R). Otherwise, there exists a fear of occurrence of buffer overflow when the RAM area is used in the subsequent sampling processing. To secure the free RAM area, it is required to reduce the audio data items and the identifying information items associated therewith stored in the RAM up to the current point of time. For this purpose, as described above, the microprocessor executes the processing to selectively discard the audio data items and the identifying information items according to a predetermined rule (17S).

When the sampling processing is stopped in response to, for example, a user's operation (17T), the microprocessor releases the timer interruption set in step 17C (17U). The microprocessor then executes end processing, namely, releases the resources secured in step 17B (17V) and enters the state after completion of the sampling processing (17W).

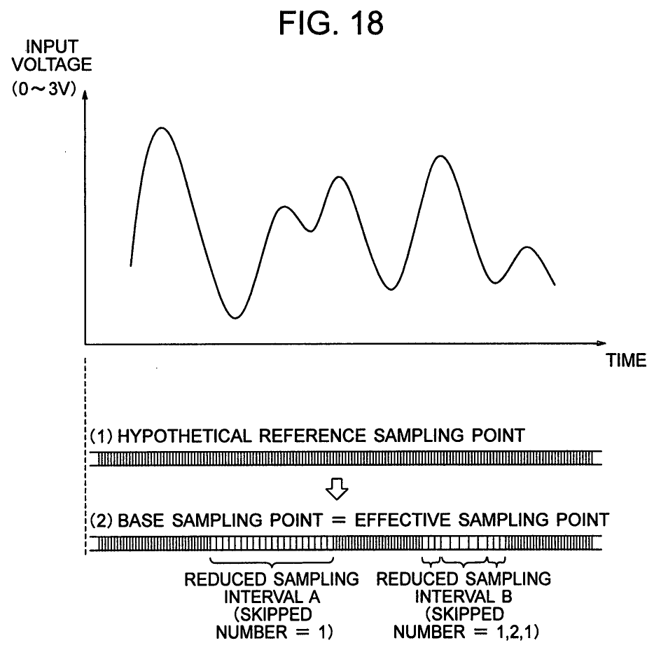

FIG. 18 shows an outline of the voice waveform sampling processing in a second embodiment of the transmission-side terminal.

As FIG. 16, FIG. 18 shows in its upper section an example of an input waveform S3 to the AD converter ADC. Similarly, FIG. 18 shows in its lower section a sequence of sampling points of time along the same time axis as for the input waveform S3. Incidentally, virtual base sampling points are shown in (1) of FIG. 18. In the embodiment, although the base sampling is not actually conducted along the virtual base sampling points of time, but the virtual base sampling points represent a fixed period as a reference to conduct the base sampling. Actually, the base sampling is conducted along the sequence of points of time shown in (2) of FIG. 18 and the sampling frequency is variable with respect to time. In an ordinary state, the base sampling points are almost equal to those shown in (1). However, in the reduced sampling interval A, the sampling is conducted at every second sampling points. On the other hand, the reduced sampling interval B includes three sub-intervals 1, 2, 3. In the subinterval 1, the sampling is conducted at every second sampling points. In the sub-interval 2, the sampling is conducted at every third sampling points. In the subinterval 3, the sampling is conducted at every second sampling points. In this way, there is created audio data in which the effective sampling period varies with respect to time. The audio data is stored in the RAM together with identifying information associated therewith and is transmitted therefrom in the form of a radio packet.

Although the second embodiment differs in specific operations from the first embodiment, the effective sampling data created by the second embodiment is almost equal to that of the first embodiment. The difference resides in that while the audio data stored in the RAM is selectively discarded to create the effective sampling data of the variable frequency in the first embodiment, the effective sampling data of the variable frequency is created when the audio data is obtained from the AD converter ADC in the second embodiment. That is, the microprocessor executes the sampling processing by changing the sampling period in association with the free RAM area capacity, the processing load on the microprocessor, the radio communication quality, and the transmission rate for radio communication. Since the microprocessor does not execute the processing to store in the RAM the data sampled with a fixed frequency, the processing load on the microprocessor is lowered and the required RAM capacity is reduced.

Due to the characteristic described above, the second embodiment is highly adaptable to the voice transmission of realtime type. On the other hand, the reduced sampling processing is executed in realtime operation. It is hence required that the operation to control the reduced sampling is conducted according to a realtime index at an instantaneous point of time. There does not exists marginal time to determine the final effective sampling data. Therefore, if a predetermined time difference is allowed between the base sampling and the radio packet transmission, for example, in the audio transmission of on-demand type, the first embodiment is more adaptable than the second embodiment. Naturally, by using the control operation of the first embodiment and that of he second embodiment, there may be implemented an effective sampling data creation method highly adaptable to the audio transmission of on-demand type and the audio transmission of realtime type.

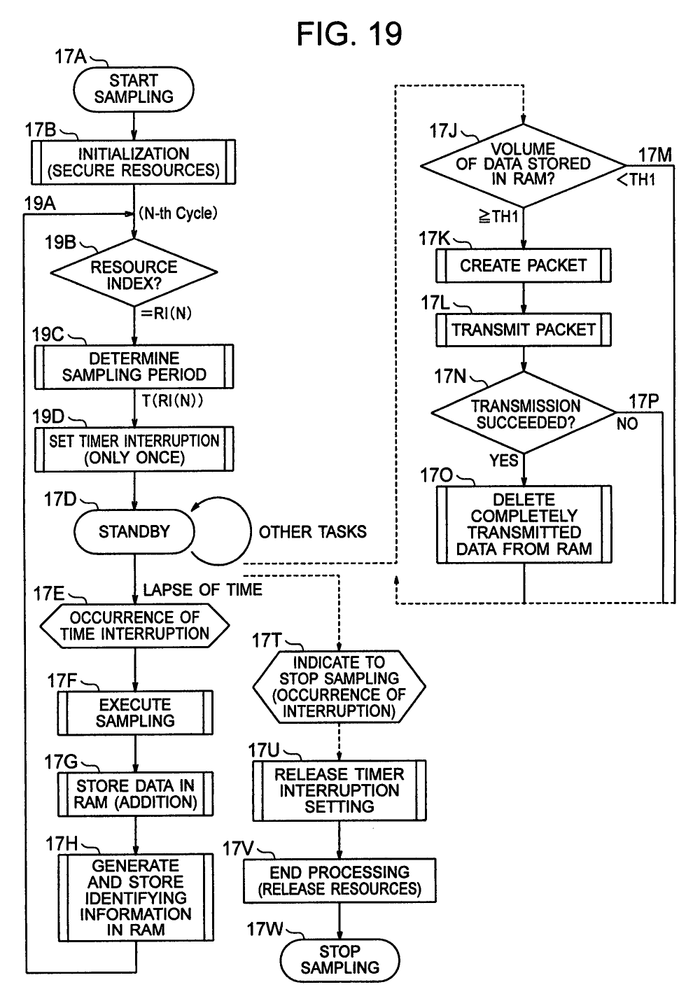

FIG. 19 shows a processing flow conducted by the microprocessor in the second embodiment of the transmission-side terminal shown in FIG. 18.

The processing flow of FIG. 19 includes base sampling processing indicated by steps 17A to 17H and 19A to 19D, radio packet transmission processing indicated by steps 17J to 17P, and sampling stop processing indicated by steps 17T to 17W. Most processing is equivalent to that of the first embodiment of the terminal on the transmission side shown in FIG. 17. In FIG. 19, processing steps of such processing are assigned with the same reference numerals as in FIG. 17. Description will now be given of only the difference in the processing, specifically, the processing of steps 19A to 19D.

After the initialization step 17B or after the previous sampling step (19A), the microprocessor checks a predetermined resource index (19B). In this situation, the resource index may be the free RAM area as in the first embodiment shown in FIG. 17. However, there may be employed an index representing the processing load on the microprocessor or an index representing the radio communication quality or transmission rate. There may also be employed an index which comprehensively evaluates these resource states. FIG. 19 employs such index RI(N) represented in a general form of an evaluation index in the sampling cycle (N-th cycle).

Next, based on the value of the resource index RI(N) obtained as above, the microprocessor determines the sampling period in the sampling cycle (19C). The sampling period is expressed in a general form, i.e., T(RI(N)) as a function of the resource index RI(N). Based on the sampling period, the microprocessor sets a timer interruption value to conduct the base sampling (19D). For example, it is assumed that a large value of the resource index RI(N) indicates that the amount of resources used by the terminal on the transmission side is increasing. In this case, these items are defined such that the sampling period T(RI(N)) increases as the resource index RI(N) increases. That is, when the amount of resources increases, a long sampling period is designated to reduce the processing load on the microprocessor, the amount of area used in the RAM, and the amount of data to be transmitted. As a result, the increase in the amount of resources used is suppressed and the operation is stabilized.

In the embodiment, the base sampling period is variable for each cycle, and hence the timer interruption setting 19D is effective only for the pertinent cycle. Unlike the timer interruption setting 17C, the timer interruption setting 19D does not require the setting of “auto-reload”. At occurrence of the timer interruption in step 17E, the interruption setting is immediately released.

The processing other than that described above is substantially equal to the processing of FIG. 17, and the associated processing steps are assigned with the same reference numerals.

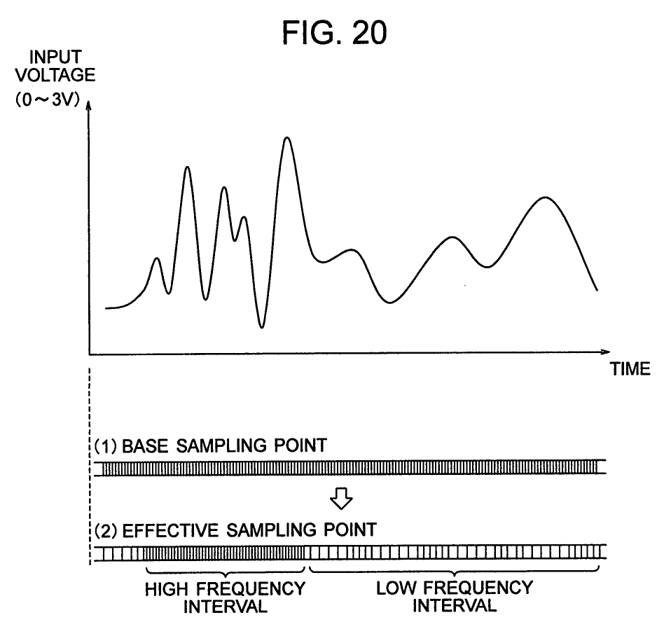

FIG. 20 shows an image of voice waveform sampling conducted by a third embodiment of the transmission-side terminal.

In the control operation examples described in conjunction with the first embodiment of FIG. 16 and the second embodiment of FIG. 18, the effective sampling frequency is adjusted in association with the amount of resources, for example, the area of the RAM used by the transmission-side terminal. In conjunction with the third embodiment, description will be given of an example of control to adjust the effective sampling frequency by following an audio frequency inputted to the transmission-side terminal. According to the control operation, the amount of resources used by the terminal can be lowered without deteriorating the quality of transmitted voice. Particularly, in consideration of the high-quality audio data compression technique, the audio data can be effectively compressed with quite a low processing load imposed on the microprocessor.

In FIG. 20, an input waveform S3 to the AD converter ADC is a waveform having a characteristic in which the frequency is high in the beginning phase and is abruptly lowered at an intermediate point.

For the input waveform, the third embodiment conducts the sampling with a fixed frequency as shown in (1) of FIG. 20. However, in each cycle of the sampling, all sampling data items are not stored in the RM, but there is employed an algorithm to selectively discard the obtained sampling data. That is, the sampling data is compared with the previous sampling data to determine whether or not the sampling data is to be stored in the RAM. Specifically, the previous sampling data is held in a register of the microprocessor. In the operation, the current sampling data is compared with the previous sampling data. If the difference therebetween is less than a predetermined threshold value, the current sampling data is not stored in the RAM, but is discarded. Otherwise, the current sampling data is stored in the RAM.

Due to such selective discarding algorithm, in the effective sampling points (2) stored in the RAM, the effective sampling frequency is large in an interval of time in which the input waveform has a high frequency and the effective sampling frequency is small in an interval of time in which the input waveform has a low frequency. As above, there is implemented a control operation to adjust the effective sampling frequency to follow the frequency input voice. Adjusting the effective sampling frequency in this way leads to advantages as follows.

When the third embodiment is employed in the sampling operation for voice in a speech of a human, the high-frequency interval appears mainly for consonants. Of the consonants, particularly, fricatives include a high-frequency component, for example, consonants of sa, shi, su, se, so; ta, chi, tsu, te, to; and ha, hi, fu, he, ho in Japanese and th, sh, f, etc. in English. These consonants include frequency components mainly ranging from three kiloherz to five kiloherz. On the other hand, vowels occupying about 80 percent to about 90 percent of the human speech in terms of time include frequency components ranging from several hundreds of herz to at most one kiloherz in ordinary cases, although depending on individuals.

Therefore, if the embodiment is applied to the sampling of the voice, only the consonants occupying only from about ten percent to about 20 percent of the speech time are sampled by using a high frequency and the remaining vowels occupying from about 80 percent to about 90 percent of the speech time are sampled by using a low frequency. As a result, while keeping the voice quality almost unchanged, it is possible to reduce the amount of sampling data items with quite high efficiency.

In an ordinary-speed conversation between humans, a period of time ranging from 20 percent to about 50 percent of the overall period of speech time is used for demarcation of speech and for consideration, and hence there occurs a no-sound period time in which speech is not conducted. According to the embodiment, the effective sampling frequency is much more lowered in the no-sound period of time. In consideration of the characteristic of the voice in the human speech, the volume of the sampling data of the voice can be reduced to a value equal to or less than one tenth of that of the effective sampling data in a case in which the base sampling data is directly used as the effective sampling data.

When compared with the conventional voice compression technique, the embodiment is quite advantageous in that the amount of resources used by the terminal is quite small. The conventional technique uses a high-level compression algorithm such as a high-speed Fourier Transform (TTF) and a prediction encoding. This requires quite a large amount of computation steps of the microprocessor and quite a large RAM capacity. On the other hand, the processing required by the embodiment is only the operation of comparison between the current sampling data with the previous sampling data. Therefore, the required amount of computation steps of the microprocessor is quite small. The sampling data is temporarily held in a register such that any sampling data satisfying a predetermined condition is discarded. As a result, the amount of sampling data to be stored in the RAM is equal to or less than one tenth that of the sampling data obtained through the fixed sampling. Even if it is taken into consideration that there is required an area to store the identifying information indicating the reproduction timing, the amount of RAM areas used in the embodiment is remarkably smaller when compared with that required in the conventional data compression technique. It is also expectable that the amount of RAM areas used in the embodiment is smaller than that required in the fixed sampling. As above, the embodiment has an aspect in which although the amount of resources used by the terminal is quite small, the voice quality is rarely deteriorated.

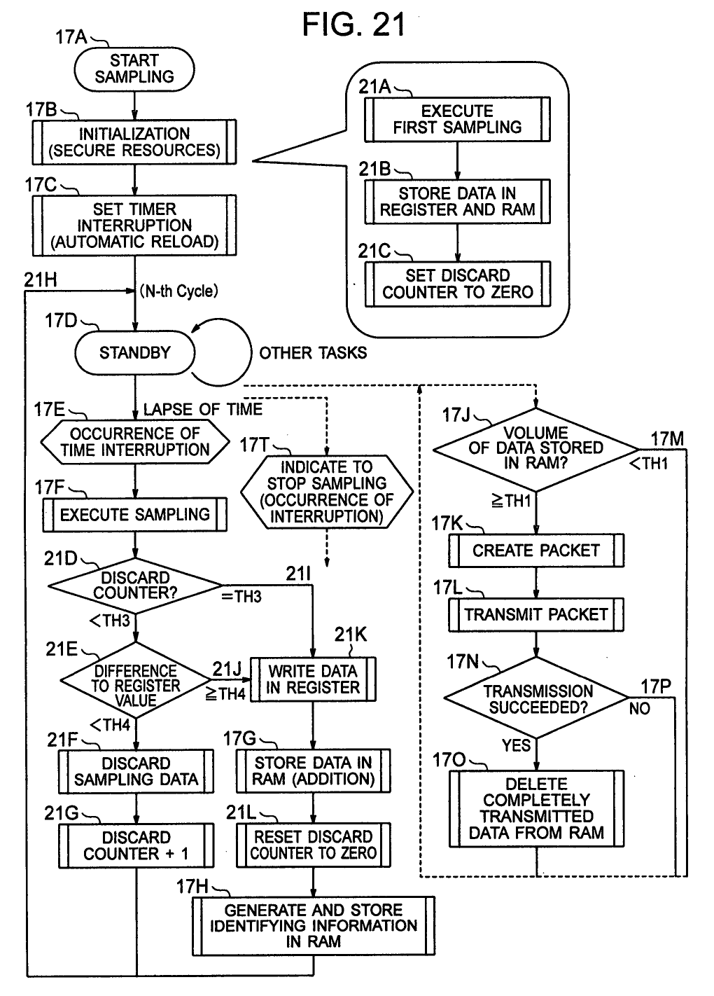

FIG. 21 shows a processing flow conducted by the microprocessor in the third embodiment of the transmission-side terminal.

The processing flow of FIG. 21 includes base sampling processing and effective sampling data creation processing indicated by steps 17A to 17H and 21A to 21L, radio packet transmission processing indicated by steps 17J to 17P, and sampling stop processing indicated by steps 17T. In FIG. 21, the same processing steps as those of FIG. 17 are assigned with the same reference numerals. Description will now be given of only the difference in the processing, specifically, the processing in steps 21A to 21L.

After the sampling processing is started, the microprocessor executes, in the initialization processing, initial sampling processing of steps 21A to 21C. In the processing, the microprocessor executes the initial sampling (21A), stores in a register and the RAM the sampling data obtained in step 21A (21B), and then initializes a discard counter to zero. The discard counter contains control information to guarantee, even when the input waveform has quite a low frequency or the no-sound interval continues, the sampling operation to be conducted at least with predetermined lowest frequency, namely, to guarantee the lowest voice quality.

In each cycle thereafter, the microprocessor executes the base sampling with the fixed frequency (17F) and checks the value in the discard counter (21D). If the value is less than a predetermined threshold value TH3, the sampling data in the cycle may be discarded. Whether or not the data is to be discarded is determined by comparing the data with the previous sampling data held in the register (21E). If the difference therebetween is less than a predetermined threshold value TH4, the sampling data is discarded (21F). The microprocessor adds one to the value in the discard counter and enters the standby state 17 for the next sampling cycle (21H). If the value of the discard counter reaches the threshold value TH3 in step 21D or if the difference is equal to or more than the threshold value TH4 in step 21E (21J), the sampling data is not discarded, but is overwritten in the register (21K), and the data is stored in the RAM (17G). Thereafter, the microprocessor resets the discard counter to zero (21L), creates identifying information corresponding to the sampling data and stores the information in the RAM (17H), and enters the standby state 17 for the next sampling cycle (21H).

In the processing, the sampling data previously selected is stored in the register as in step 21B and 21K, the current sampling data obtained in the current processing is compared with the previous sampling data. According to the result of the comparison, whether or not the sampling data of the current processing is to be discarded is determined. This implements the processing in which the effective sampling frequency is adjusted by following the frequency of the input waveform. Specifically, if the input waveform has a high frequency, the difference relative to the value stored in the register is quite frequently equal to or more than the threshold value TH4, and hence the data selection processing beginning at step 21K is frequently activated. This results in a high effective sampling frequency. On the other hand, if the input waveform has a low frequency, the difference relative to the value stored in the register is quite frequently less than the threshold value TH4. Therefore, the data discard processing beginning at step 21F is frequently activated. This results in a low effective sampling frequency. Incidentally, the data stored in the register is other than the sampling data in the previous cycle, but is the sampling data in the cycle in which the data selection processing is last activated after step 21K. Therefore, if the frequency of the input waveform is lowered to half the original value, it will be predictable that the expected value of the number of cycles lapsed by when the difference relative to the value in the register is equal to or more than the threshold value TH4 is doubled. As above, due to the processing flow, it is expectable that the effective sampling frequency follows the frequency of the input waveform with high precision.

Even for one and the same voice, if the speech is conducted with the microphone apart from the person making the speech, the sound pressure level is low in the input phase. Therefore, the difference relative to the value in the register is disadvantageously small even the input waveform has a high frequency. Therefore, to make the effective sampling frequency follow the variation in the frequency of the input waveform while preventing the influence from the variation in the sound pressure level and thereby keeping one and the same characteristic unchanged, it is desirable that if the value in the register is large, the threshold value TH4 to select the effective sampling data is accordingly set to a large value and if the value in the register is small, the threshold value TH4 is accordingly set to a small value. For example, if the AD converter ADC has a linear input/output characteristic, there is desirably introduced a weight coefficient which is proportional to the value in the register.

To make the processing flow conduct operation according to the design target thereof, it is required that so-called “sampling theorem” is satisfied. That is, the frequency of the base sampling is at least twice the largest frequency of the input waveform. For this purpose, there is required a characteristic to cut the high-frequency component of a frequency which is more than one half of the base sampling frequency.

According to the present invention described above, it is possible to implement a speech function with high voice quality in a small-sized wireless terminal including inexpensive low-grade resources such as an inexpensive microprocessor and an inexpensive memory.

It should be further understood by those skilled in the art that although the foregoing description has been made on embodiments of the invention, the invention is not limited thereto and various changes and modifications may be made without departing from the spirit of the invention and the scope of the appended claims.

1. A data processing equipment comprising:
a processing section for extracting from first data inputted thereto a first reproduction data sequence including first reproduction data and first identifying information defining reproduction timing to reproduce the first reproduction data;
a recording section for recording the first reproduction data sequence and the first identifying information;
a control section for outputting the first reproduction data sequence recorded in the recording section;
a Digital-to-Analog (DA) converter to convert the first reproduction data sequence outputted by the control section from digital data into analog data; and
a reproducing section for reproducing the first reproduction data sequence converted by the DA converter, wherein
the control section controls timing to output the first reproduction data to the DA converter according to the first identifying information.

2. The data processing equipment according to claim 1, wherein
the control section selects, if a capacity of a free area in the recording section is equal to or less than a predetermined value, the first reproduction data from the first reproduction data sequence recorded in the recording section and discards the first reproduction data thus selected and the first identifying information corresponding to the first reproduction data.

3. The data processing equipment according to claim 1, further comprising:
an Analog-to-Digital (AD) converter to convert second data inputted thereto from analog data into digital data; and
a communication section, wherein:
the recording section records the second data converted from analog data to digital data by the AD converter;
the control section determines a data discard ratio to discard according to the data discard ratio the second data recorded in the recording section, decimates the second data according to the data discard ratio, and thereby creates a second reproduction data sequence; and
the communication section outputs the second reproduction data sequence including second reproduction data and second identifying information defining reproduction timing to reproduce the second reproduction data.

4. The data processing equipment according to claim 1, further comprising:
an Analog-to-Digital (AD) converter to convert second data inputted thereto from analog data into digital data, at a predetermined sampling period; and
a communication section, wherein:
the sampling period is changed by the control section according to a predetermined rule, each time the AD converter converts analog data into digital data;
the recording section records the second data converted from analog data to digital data by the AD converter;
the control section creates a second reproduction data sequence using the second data recorded in the recording section; and
the communication section outputs the second reproduction data sequence including second reproduction data and second identifying information defining reproduction timing to reproduce the second reproduction data.

5. The data processing equipment according to claim 1, further comprising:
an Analog-to-Digital (AD) converter to convert second data inputted thereto from analog data into digital data;
a register to store therein the second data converted from analog data into digital data; and
a communication section, wherein
the control section compares, each time a latest value of the second data is obtained, a difference between the latest value and the second data which is previously obtained and which is stored in the register, and discards the second data having the latest value without recording the second data if the difference is less than a predetermined value;
the recording section records the second data which is not discarded and which is recorded in the register;
the control section creates a second reproduction data sequence using the second data recorded in the recording section; and
the communication section outputs the second reproduction data sequence including second reproduction data and second identifying information defining reproduction timing to reproduce the second reproduction data.

6. The data processing equipment according to claim 1, wherein:
the first identifying information is bit information defining a reproduction interval of time to reproduce the first reproduction data, according to a gap between bits; and
the control section outputs the first reproduction data at a reproduction point of time defined using the bit information.

7. The data processing equipment according to claim 6, wherein
the control section selects, if a capacity of a free area in the recording section is equal to or less than a predetermined value, the first reproduction data from the first reproduction data sequence recorded in the recording section and discards the first reproduction data thus selected and the first identifying information corresponding to the first reproduction data.

8. The data processing equipment according to claim 6, further comprising:
an Analog-to-Digital (AD) converter to convert second data inputted thereto from analog data into digital data; and
a communication section, wherein:
the recording section records the second data converted into digital data by the AD converter;
the control section determines a data discard ratio to discard according to the data discard ratio the second data recorded in the recording section, decimates the second data according to the data discard ratio, and thereby creates a second reproduction data sequence; and
the communication section outputs the second reproduction data sequence including second reproduction data and second identifying information defining reproduction timing to reproduce the second reproduction data.

9. The data processing equipment according to claim 6, further comprising:
an Analog-to-Digital (AD) converter to convert second data inputted thereto from analog data into digital data, at a predetermined sampling period; and
a communication section, wherein:
the sampling period is changed by the control section according to a predetermined rule, each time the AD converter converts analog data into digital data;
the recording section records the second data converted into digital data by the AD converter;
the control section creates a second reproduction data sequence using the second data recorded in the recording section; and
the communication section outputs the second reproduction data sequence including second reproduction data and second identifying information defining reproduction timing to reproduce the second reproduction data.

10. The data processing equipment according to claim 6, further comprising:
an Analog-to-Digital (AD) converter to convert second data inputted thereto from analog data into digital data;
a register to store therein the second data converted from analog data into digital data; and
a communication section, wherein
the control section compares, each time a latest value of the second data is obtained, a difference between the latest value and the second data previously obtained and stored in the register, and discards the second data having the latest value is discarded, not recorded, if the difference is less than a predetermined value;
the recording section records the second data which is not discarded and which is recorded in the register;
the control section creates a second reproduction data sequence using the second data recorded in the recording section; and
the communication section outputs the second reproduction data sequence including second reproduction data and second identifying information defining reproduction timing to reproduce the second reproduction data.

11. The data processing equipment according to claim 1, wherein:
the first identifying information is information indicating a reproduction interval of time to reproduce the first reproduction data, the first reproduction data being successive in time series; and
the control section outputs, after outputting the first reproduction data to the DA converter, first reproduction data successively following the first reproduction data outputted to the DA converter, according to the reproduction interval of time.

12. The data processing equipment according to claim 11, wherein
the control section selects, if a capacity of a free area in the recording section is equal to or less than a predetermined value, the first reproduction data from the first reproduction data sequence recorded in the recording section and discards the first reproduction data thus selected and the first identifying information corresponding to the first reproduction data.

13. The data processing equipment according to claim 11, further comprising:
an Analog-to-Digital (AD) converter to convert second data inputted thereto from analog data into digital data; and
a communication section, wherein:
the recording section records the second data converted into digital data by the AD converter;
the control section determines a data discard ratio to discard according to the data discard ratio the second data recorded in the recording section, decimates the second data according to the data discard ratio, and thereby creates a second reproduction data sequence; and
the communication section outputs the second reproduction data sequence including second reproduction data and second identifying information defining reproduction timing to reproduce the second reproduction data.

14. The data processing equipment according to claim 11, further comprising:
an Analog-to-Digital (AD) converter to convert second data inputted thereto from analog data into digital data, at a predetermined sampling period; and
a communication section, wherein:
the sampling period is changed by the control section according to a predetermined rule, each time the AD converter converts analog data into digital data;
the recording section records the second data converted into digital data by the AD converter;
the control section creates a second reproduction data sequence using the second data recorded in the recording section; and
the communication section outputs the second reproduction data sequence including second reproduction data and second identifying information defining reproduction timing to reproduce the second reproduction data.

15. The data processing equipment according to claim 11, further comprising:
an Analog-to-Digital (AD) converter to convert second data inputted thereto from analog data into digital data;
a register to store therein the second data converted from analog data into digital data; and
a communication section, wherein
the control section compares, each time a latest value of the second data is obtained, a difference between the latest value and the second data previously obtained and stored in the register, and discards the second data having the latest value is discarded, not recorded, if the difference is less than a predetermined value;
the recording section records the second data which is not discarded and which is recorded in the register;
the control section creates a second reproduction data sequence using the second data recorded in the recording section; and
the communication section outputs the second reproduction data sequence including second reproduction data and second identifying information defining reproduction timing to reproduce the second reproduction data.

16. The data processing equipment according to claim 11, wherein:
the first identifying information further includes information indicating the number of data items successively reproduced with the reproduction interval of time; and
the control section outputs according to the reproduction interval of time, after outputting the first reproduction data, the first reproduction data items of which the number is indicated by the number of data items.

17. The data processing equipment according to claim 16, wherein
the control section selects, if a capacity of a free area in the recording section is equal to or less than a predetermined value, the first reproduction data from the first reproduction data sequence recorded in the recording section and discards the first reproduction data thus selected and the first identifying information corresponding to the first reproduction data.

18. The data processing equipment according to claim 16, further comprising:
an Analog-to-Digital (AD) converter to convert second data inputted thereto from analog data into digital data; and
a communication section, wherein:
the recording section records the second data converted into digital data by the AD converter;
the control section determines a data discard ratio to discard according to the data discard ratio the second data recorded in the recording section, decimates the second data according to the data discard ratio, and thereby creates a second reproduction data sequence; and
the communication section outputs the second reproduction data sequence including second reproduction data and second identifying information defining reproduction timing to reproduce the second reproduction data.

19. The data processing equipment according to claim 16, further comprising:
an Analog-to-Digital (AD) converter to convert second data inputted thereto from analog data into digital data, at a predetermined sampling period; and
a communication section, wherein:
the sampling period is changed by the control section according to a predetermined rule, each time the AD converter converts analog data into digital data;
the recording section records the second data converted into digital data by the AD converter;
the control section creates a second reproduction data sequence using the second data recorded in the recording section; and
the communication section outputs the second reproduction data sequence including second reproduction data and second identifying information defining reproduction timing to reproduce the second reproduction data.

20. The data processing equipment according to claim 16, further comprising:
an Analog-to-Digital (AD) converter to convert second data inputted thereto from analog data into digital data;
a register to store therein the second data converted from analog data into digital data; and
a communication section, wherein
the control section compares, each time a latest value of the second data is obtained, a difference between the latest value and the second data previously obtained and stored in the register, and discards the second data having the latest value is discarded, not recorded, if the difference is less than a predetermined value;
the recording section records the second data which is not discarded and which is recorded in the register;
the control section creates a second reproduction data sequence using the second data recorded in the recording section; and
the communication section outputs the second reproduction data sequence including second reproduction data and second identifying information defining reproduction timing to reproduce the second reproduction data.

21. A data processing equipment, comprising:
an Analog-to-Digital (AD) converter for converting data inputted thereto from analog data to digital data to create a sampling data sequence;
a register for storing therein the sampling data sequence;
a control section for determining whether or not the sampling data is discarded, according to a difference between values of the sampling data successively stored in the register;
a recording section for storing therein a sequence of the sampling data which is not discarded and which is stored in the register; and
a communication section, wherein:
the control section creates identifying information defining reproduction timing to reproduce sampling data included in the sampling data sequence and a reproduction data sequence using the sampling data sequence recorded in the recording section; and
the communication section outputs the identifying information and the reproduction data sequence.

22. The data processing equipment according to claim 21, wherein
the control section does not discard the sampling data if the number of sampling data to be successively discarded exceeds a predetermined value.

23-28. (canceled)
